(19) United States
(12) Patent Application Publication
(10) Pub. No.: US 2026/0046776 A1
(43) Pub. Date: Feb. 12, 2026

(54) METHOD AND APPARATUS FOR TRANSMITTING AND RECEIVING WAKE-UP SIGNAL IN WIRELESS COMMUNICATION SYSTEM

(71) Applicant: SAMSUNG ELECTRONICS CO., LTD., Suwon-si (KR)

(72) Inventors: Seunghoon CHOI, Suwon-si (KR); Hyewon YANG, Suwon-si (KR); Hyoungju JI, Suwon-si (KR)

(21) Appl. No.: 19/298,070

(22) Filed: Aug. 12, 2025

(30) Foreign Application Priority Data
Aug. 12, 2024 (KR) 10-2024-0107777

(51) Int. Cl. H04W 52/02; H04L 5/00; H04W 68/02

(52) U.S. Cl. CPC H04W 52/0235; H04L 5/0044; H04W 68/02

(57) ABSTRACT

A method performed by a user equipment (UE) includes receiving time division duplex uplink-downlink (TDD UL-DL) configuration information via a higher layer signaling, identifying at least one UL symbol configured for the UE based on the TDD UL-DL configuration information, and based on the UE in a radio resource control (RRC)_IDLE or an RRC_INACTIVE state, monitoring a wake up signal (WUS) on one or more symbols except the identified at least one UL symbol.

### CROSS-REFERENCE TO RELATED APPLICATION

This application is based on and claims priority under 35 U.S.C. § 119 to Korean Patent Application No. 10-2024-0107777, filed on Aug. 12, 2024, in the Korean Intellectual Property Office, the disclosure of which is incorporated by reference herein in its entirety.

### BACKGROUND

### 1. Field

The disclosure relates to a wireless communication system, and more particularly, to a method and apparatus for transmitting and receiving a wake-up signal to and from a user equipment (UE) in a wireless communication system.

### 2. Description of the Related Art

A 5^{th} generation (5G) mobile communication technology defines a broad frequency band to enable a high data rate and new services, and may be implemented not only in a “Sub 6 GHz” band including 3.5 GHz but also in an ultra-high frequency band (“Above 6 GHz”) referred to as millimeter wave (mmWave) including 28 GHz, 39 GHz, and the like. Also, for 6th generation (6G) mobile communication technology referred to as a system beyond 5G communication (beyond 5G), in order to achieve a data rate fifty times faster than the 5G mobile communication technology and ultra-low latency one-tenth of the 5G mobile communication technology, implementation of the 6G mobile communication technology in the terahertz band (e.g., 95 GHz to 3 THz band) is being considered.

In the early phase of the development of the 5G mobile communication technology, in order to support services and satisfy performance requirements of enhanced Mobile BroadBand (eMBB), Ultra Reliable Low Latency Communications (URLLC), and massive Machine-Type Communications (mMTC), there has been ongoing standardization about beamforming and massive multiple input multiple output (MIMO) for mitigating pathloss of radio waves and increasing transmission distances of radio waves in a mmWave band, supporting numerologies (e.g., operation of multiple subcarrier spacings) for efficiently utilizing mmWave resources and dynamic operation of slot formats, initial access technology for supporting multi-beam transmission and broadband, definition and operation of bandwidth part (BWP), new channel coding methods such as a low density parity check (LDPC) code for a large amount of data transmission and a polar code for highly reliable transmission of control information, L2 pre-processing, and network slicing for providing a dedicated network specialized to a specific service.

Currently, there are ongoing discussions about improvement and performance enhancement of initial 5G mobile communication technology in consideration of services to be supported by the 5G mobile communication technology, and there has been physical layer standardization of technologies such as vehicle-to-everything (V2X) for aiding driving determination by autonomous vehicles based on information regarding locations and states of vehicles transmitted by the vehicles and for enhancing user convenience, new radio unlicensed (NR-U) aimed at system operations conforming to various regulation-related requirements in unlicensed bands, NR user equipment (NR UE) power saving, non-terrestrial network (NTN) that is UE-satellite direct communication for providing coverage in an area in which communication with terrestrial networks is unavailable, and positioning.

Moreover, there has been ongoing standardization of air interface architecture/protocol regarding technologies such as industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR), and standardization of system architecture/service regarding a 5G baseline architecture (e.g., service based architecture or service based interface) for combining network functions virtualization (NFV) and software-defined networking (SDN) technologies, and mobile edge computing (MEC) for receiving services based on UE locations.

When the 5G mobile communication system is commercialized, connected devices being on a rapidly increasing trend are being predicted to be connected to communication networks, and therefore, it is predicted that enhancement of functions and performance of the 5G mobile communication system and integrated operations of the connected devices are performed. To this end, new researches are scheduled for extended Reality (XR) for efficiently supporting Augmented Reality (AR), Virtual Reality (VR), Mixed Reality (MR) and the like, 5G performance improvement and complexity reduction by utilizing artificial intelligence (AI) and machine learning (ML), AI service support, metaverse service support, drone communication, and the like.

Also, such development of the 5G mobile communication system will serve as a basis for developing not only new waveforms for providing coverage in terahertz bands of 6G mobile communication technology, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of the 6G mobile communication technology and improving system networks, AI-based communication technology for implementing system optimization by utilizing satellites and AI from a design stage and internalizing end-to-end AI support functions, and next-generation distributed computing technology for implementing services at levels of complexity exceeding the limit of UE operation capability by utilizing ultra-high-performance communication and computing resources.

### SUMMARY

Additional aspects will be set forth in part in the description which follows and, in part, will be apparent from the description, or may be learned by practice of the presented embodiments of the disclosure.

According to an embodiment of the disclosure, a method performed by a user equipment (UE) includes: receiving time division duplex uplink-downlink (TDD UL-DL) configuration information via a higher layer signaling; identifying at least one UL symbol configured for the UE based on the TDD UL-DL configuration information; and based on the UE in a radio resource control (RRC)_IDLE or an RRC_INACTIVE state, monitoring a wake up signal (WUS) on one or more symbols except the identified at least one UL symbol.

The method may further include: in case that a first offset for a low power WUS occasion (LO) is configured based on a higher layer parameter, identifying a reference frame for monitoring the WUS that starts a number of frames prior to a paging frame associated with the LO, wherein the number of frames is indicated by the first offset.

The method may further include: identifying a first monitoring occasion for the WUS, based on a second offset relative to the reference frame.

The second offset may be configured by a higher layer parameter.

According to an embodiment of the disclosure, a method performed by a base station, includes: transmitting time division duplex uplink-downlink (TDD UL-DL) configuration information via a higher layer signaling, wherein at least one UL symbol configured for a user equipment (UE) is identified based on the TDD UL-DL configuration information; and based on the UE in a radio resource control (RRC)_IDLE or an RRC_INACTIVE state, transmitting a wake up signal (WUS) on one or more symbols except the identified at least one UL symbol.

A user equipment (UE) includes: a transceiver; and at least one processor coupled with the transceiver and configured to: receive time division duplex uplink-downlink (TDD UL-DL) configuration information via a higher layer signaling, identify at least one UL symbol configured for the UE based on the TDD UL-DL configuration information, and based on the UE in a radio resource control (RRC)_IDLE or an RRC_INACTIVE state, monitor a wake up signal (WUS) on one or more symbols except the identified at least one UL symbol.

According to an embodiment of the disclosure, a base station includes: a transceiver; and at least one processor coupled with the transceiver and configured to: transmit time division duplex uplink-downlink (TDD UL-DL) configuration information via a higher layer signaling, wherein at least one UL symbol configured for a user equipment (UE) is identified based on the TDD UL-DL configuration information, and based on the UE in a radio resource control (RRC)_IDLE or an RRC_INACTIVE state, transmit a wake up signal (WUS) on one or more symbols except the identified at least one UL symbol.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates a basic structure of a time-frequency resource domain in a wireless communication system according to an embodiment of the disclosure;

FIG. 2 illustrates a time domain mapping structure and a beam sweeping operation of a synchronization signal according to an embodiment of the disclosure;

FIG. 3 illustrates a flow of signals for random access (RA) according to an embodiment of the disclosure;

FIG. 4 illustrates a flow of signals for a user equipment (UE) to report UE capability information to a base station (BS) according to an embodiment of the disclosure;

FIG. 5 illustrates an example of state switching of a BS and a UE and a state of a UE according to a state of a BS according to an embodiment of the disclosure;

FIG. 6 illustrates an example of configuring a resource for transmitting and receiving a wake-up signal (WUS) according to an embodiment of the disclosure;

FIG. 7 illustrates an example of a method of defining a correlation between an LP-WUS occasion/WUS monitoring occasion (LO/MO) monitored by a UE and a paging frame/paging occasion (PF/PO) for receiving paging according to an embodiment of the disclosure;

FIG. 8 illustrates an example of Option 1 of a method of defining a correlation between an LO/MO monitored by a UE and a PF/PO for receiving paging according to an embodiment of the disclosure;

FIG. 9 illustrates an example of Option 1 of a method of defining a correlation between an LO/MO monitored by a UE and a PF/PO for receiving paging according to an embodiment of the disclosure;

FIG. 10 illustrates an example of Option 2 of a method of defining a correlation between an LO/MO monitored by a UE and a PF/PO for receiving paging according to an embodiment of the disclosure;

FIG. 11 illustrates an example of Option 2 of a method of defining a correlation between an LO/MO monitored by a UE and a PF/PO for receiving paging according to an embodiment of the disclosure;

FIG. 12 illustrates an example of Option 3 of a method of defining a correlation between an LO/MO monitored by a UE and a PF/PO for receiving paging according to an embodiment of the disclosure;

FIG. 13 illustrates an example of Option 3 of a method of defining a correlation between an LO/MO monitored by a UE and a PF/PO for receiving paging according to an embodiment of the disclosure;

FIG. 14 illustrates a flowchart for an operating method of a UE according to an embodiment of the disclosure;

FIG. 15 illustrates a flowchart for an operating method of a BS according to an embodiment of the disclosure;

FIG. 16 illustrates a configuration of a UE according to an embodiment of the disclosure; and

FIG. 17 illustrates a configuration of a BS according to an embodiment of the disclosure.

### DETAILED DESCRIPTION

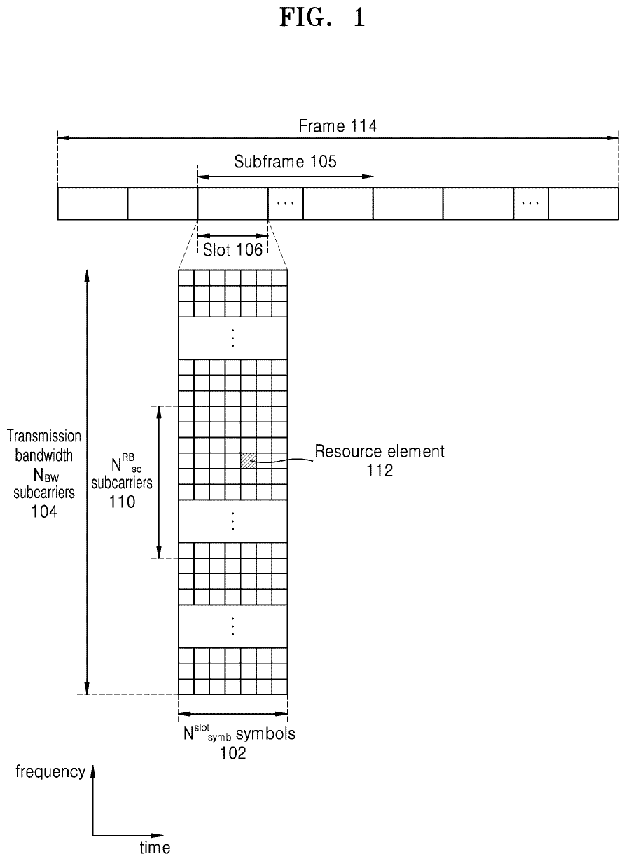

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Throughout the disclosure, the expression “at least one of a, b or c” indicates only a, only b, only c, both a and b, both a and c, both b and c, all of a, b, and c, or variations thereof.

The terms used herein will be briefly described, and the disclosure will be described in detail.

The terms used herein are general terms currently widely used in the art in consideration of functions in the disclosure, but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the disclosure.

It will be understood that when a certain part “includes” a certain component, the part does not exclude another component but may further include another component, unless the context clearly dictates otherwise. Also, the term “ . . . unit” or “ . . . module” refers to a unit that performs at least one function or operation, and the unit may be implemented as hardware or software or as a combination of hardware and software.

Exemplary embodiments of the disclosure will be described in detail with reference to the accompanying drawings. In the accompanying drawings, it will be understood that like reference numerals denote like elements. Also, detailed descriptions of well-known functions and configurations in the art may be omitted when it is deemed that they may unnecessarily obscure the essence of the disclosure.

In the following description of embodiments of the disclosure, descriptions of techniques that are well known in the art and not directly related to the disclosure are omitted. This is to clearly convey the gist of the disclosure by omitting an unnecessary description.

For the same reason, some elements in the accompanying drawings are exaggerated, omitted, or schematically illustrated. Also, the size of each element may not substantially reflect its actual size. In the drawings, the same or corresponding elements are denoted by the same reference numerals.

The advantages and features of the disclosure, and methods of achieving the same, will become apparent with reference to embodiments of the disclosure described below in detail in conjunction with the accompanying drawings. However, the disclosure may be embodied in many different forms and should not be construed as being limited to the embodiments set forth below. Rather, the embodiments are provided so that the disclosure will be thorough and complete and will fully convey the concept of the disclosure to one of ordinary skill in the art to which the disclosure pertains, and the disclosure will only be defined by the appended claims. In the specification, the same reference numerals denote the same elements.

It will be understood that each block of flowchart illustrations and combinations of blocks in the flowchart illustrations may be implemented by computer program instructions. Because these computer program instructions may be loaded into a processor of a general-purpose computer, special purpose computer, or other programmable data processing equipment, the instructions, which are executed via the processor of the computer or other programmable data processing equipment generate means for performing the functions specified in the flowchart block(s). Because these computer program instructions may also be stored in a computer-executable or computer-readable memory that may direct the computer or other programmable data processing equipment to function in a particular manner, the instructions stored in the computer-executable or computer-readable memory may produce an article of manufacture including instruction means for performing the functions stored in the flowchart block(s). Because the computer program instructions may also be loaded into a computer or other programmable data processing equipment, a series of operational steps may be performed on the computer or other programmable data processing equipment to produce a computer implemented process, and thus, the instructions executed on the computer or other programmable data processing equipment may provide steps for implementing the functions specified in the flowchart block(s).

It should be appreciated that the blocks in each flowchart and combinations of the flowcharts may be performed by one or more computer programs which include computer executable instructions. The one or more computer programs may be stored in a single memory or the one or more computer programs may be divided with different portions stored in different multiple memories.

Any of the functions or operations described herein may be processed by one processor or a combination of processors. One processor or a combination of processors is circuitry performing processing, and may include circuitry such as an application processor (AP), a communication processor (CP), a graphics processing unit (GPU), a neural processing unit (NPU) a microprocessor unit (MPU), a system on chip (SoC), or an integrated circuit (IC).

The processor may include various processing circuits and/or a plurality of processors. For example, the term “processor” used in the specification including the claims may include various processing circuits including at least one processor. In the at least one processor, one or more processors may be configured to perform various functions described herein, individually and/or collectively, in a distributed fashion. As used herein, the “processor,”,” “at least one processor,” and “one or more processors” may be configured to perform various functions. However, these terms cover, without limitation, a situation where one processor performs some of functions and other processors perform others of the functions, and a situation where a single processor may perform all functions. Also, the at least one processor may include a combination of processors for performing various functions of disclosed functions in a distributed fashion. The at least one processor may execute program instructions to achieve or perform various functions.

Also, each block may represent a module, segment, or portion of code, which includes one or more executable instructions for implementing specified logical function(s). It should also be noted that in some alternative implementations, the functions noted in the blocks may occur out of the order. For example, two blocks shown in succession may in fact be executed substantially concurrently or the blocks may sometimes be executed in reverse order, according to the functionality involved.

The term “ . . . unit” used in the present embodiment of the disclosure refers to a software or hardware component, such as a field-programmable gate array (FPGA) or an application-specific integrated circuit (ASIC), which performs certain tasks. However, the term “ . . . unit” does not mean to be limited to software or hardware. A “ . . . unit” may be configured to be in an addressable storage medium or may be configured to operate one or more processors. Accordingly, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in components and “ . . . units” may be combined into fewer components and “ . . . units” or may be further separated into additional components and “ . . . units.” Furthermore, components and “ . . . units” may be implemented to operate one or more central processing units (CPUs) in a device or a secure multimedia card. Also, a “ . . . unit” in an embodiment may include one or more processors.

As used herein, each of such phrases as “A/B,” “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in another aspect (e.g., importance or order).

In the following descriptions of the disclosure, well-known functions or configurations are not described in detail because they would obscure the gist of the disclosure with unnecessary details. Hereinafter, embodiments of the disclosure will be described with reference to the accompanying drawings.

Hereinafter, terms for identifying access nodes, terms indicating network entities, terms indicating messages, terms indicating an interface between network entities, and terms indicating various pieces of identification information used herein are exemplified for convenience of explanation. Accordingly, the disclosure is not limited to the terms described below, and other terms indicating objects having equal technical meanings may be used.

In the following description, a physical channel and a signal may be interchangeably used with data or a control signal. For example, a physical downlink shared channel (PDSCH) is a term indicating a physical channel through which data is transmitted, but the PDSCH may also be used to indicate data. That is, in the disclosure, when a “physical channel is transmitted,” it may be interpreted as “data or a signal is transmitted through a physical channel.”

Hereinafter, in the disclosure, higher layer signaling refers to a method of transmitting a signal from a base station to a terminal by using a downlink data channel of a physical layer or transmitting a signal from a terminal to a base station by using an uplink data channel of a physical layer. Higher layer signaling may be radio resource control (RRC) signaling or media access control (MAC) control element (CE).

Also, in the disclosure, various embodiments will now be described by using terms and names defined in some communication standards (e.g., the 3^{rd} generation partnership project (3GPP)), but the disclosure is not limited to the terms and names. Various embodiments of the disclosure may be easily modified and applied to other communication systems. Also, the term “terminals (UEs)” may refer to not only mobile phones, smartphones, Internet of things (IoT) devices, and sensors but also other wireless communication devices.

Hereinafter, a base station is an entity that allocates resources to a UE, and may be at least one of a next-generation node B (gNode B/gNB), an evolved node B (eNode B/eNB), a Node B, a base station (BS), a radio access unit, a BS controller, or a node on a network. A terminal may include a UE, a mobile station (MS), a cellular phone, a smartphone, a computer, or a multimedia system capable of performing a communication function. However, the disclosure is not limited to the above examples. Although long term evolution (LTE), LTE-Advanced (LTE-A), or New Radio (NR) systems are mentioned as examples in the following description, embodiments of the disclosure may also be applied to other communication systems having similar technical backgrounds or channel types. Furthermore, various embodiments of the disclosure are applicable to other communication systems through modification at the discretion of one of ordinary skill in the art without greatly departing from the scope of the disclosure.

In order to satisfy exponentially increasing demand with respect wireless data traffic, initial standards of the 5^{th}-generation (5G) system or the NR access technology which is a next-generation communication system after LTE or evolved universal terrestrial radio access (E-UTRA) and LTE-A or E-UTRA evolution are completed. Compared to the legacy mobile communication system focusing general voice/data communications, the 5G system aims to satisfy various services and requirements, such as enhanced Mobile BroadBand (eMBB) services for improving the voice/data communication, Ultra-Reliable and Low Latency Communication (URLLC) services, massive MTC (mMTC) services for supporting communication between a massive number of devices, etc.

Compared to the legacy LTE and LTE-A where a maximum system transmission bandwidth for a single carrier is limited to 20 MHz, the 5G system aims to provide a high-speed data service at several Gbps by using a very large ultra-wide bandwidth. Accordingly, for the 5G system, an ultra-high frequency band from several GHz up to 100 GHz, in which frequencies having ultrawide bandwidths are easily made available, is being considered as a candidate frequency. In addition, wide-bandwidth frequencies for the 5G system may be obtained by reassigning or allocating frequencies among frequency bands included in a range of several hundreds of MHz to several GHz used by the legacy mobile communication systems.

A radio wave in the ultra-high frequency band has a wavelength of several millimeters (mm) and is also referred to as a millimeter wave (mmWave). However, in the ultra-high frequency band, a pathloss of radio waves increases with an increase in frequency, and thus, a coverage range of a mobile communication system is reduced.

In order to overcome the reduction in coverage in the ultra-high frequency band, a beamforming technology is applied to increase a radio wave arrival distance by focusing a radiation energy of radio waves to a certain target point using a plurality of antennas. That is, a signal to which the beamforming technology is applied has a relatively narrow beam width, and radiation energy is concentrated within the narrow beam width, so that the radio wave arrival distance is increased. The beamforming technology may be applied at both transmitter and receiver. In addition to increasing the coverage range, the beamforming technology also has an effect of reducing interference in a region other than a beamforming direction. In order to appropriately implement the beamforming technology, an accurate transmission/reception beam measurement and feedback method is performed. The beamforming technology may be applied to a control channel or a data channel having a one-to-one correspondence between a certain UE and a BS. Also, in order to increase coverage, the beamforming technology may be applied for control channels and data channels via which the BS transmits, to multiple UEs in a system, common signals such as a synchronization signal, a physical broadcast channel (PBCH), and system information. When the beamforming technology is applied to the common signals, a beam sweeping technique of transmitting a signal by changing a beam direction is additionally applied to allow the common signals to reach a UE located at any position within a cell.

As another requirement for the 5G systems, an ultra-low latency service with a transmission delay of about 1 ms between a transmitter and a receiver is performed. As a method for reducing the transmission delay, a frame structure based on a short transmission time interval (TTI) compared to that in LTE and LTE-A needs to be designed. A TTI is a basic time unit for performing scheduling, and a TTI in the legacy LTE and LTE-A systems corresponds to one subframe with a length of 1 ms. For example, as a short TTI for satisfying the requirement for the ultra-low latency service in the 5G systems, TTIs of 0.5 ms, 0.25 ms, 0.125 ms, etc. that are shorter than the TTI in the legacy LTE and LTE-A systems may be supported.

FIG. 1 illustrates a basic structure of a time-frequency resource domain in a wireless communication system according to an embodiment of the disclosure.

FIG. 1 illustrates a basic structure of a time-frequency resource domain that is a radio resource region over which data or a control channel of a 5G communication system is transmitted.

Referring to FIG. 1, in FIG. 1, a horizontal axis represents a time domain and a vertical axis represents a frequency domain. A minimum transmission unit in the time domain of the wireless communication system is an orthogonal frequency division multiplexing (OFDM) symbol, and

$${N}_{symb}^{slot}$$

symbols 102 may be gathered to constitute one slot 106, and

$${N}_{slot}^{subframe}$$

slots may be gathered to constitute one subframe 105. A length of the subframe 105 may be 1.0 ms, and 10 subframes may be gathered to constitute one frame 114 of 10 ms. A minimum transmission unit in the frequency domain is a subcarrier, and N_{BW} subcarriers 104 may be gathered to constitute a full system transmission bandwidth.

A basic unit of a resource in the time-frequency domain is a resource element (RE) 112 and may be defined as an OFDM symbol index and a subcarrier index A resource block (RB) or a physical resource block (PRB) may be defined as

$${N}_{sc}^{RB}$$

consecutive subcarriers 110 in the frequency domain. In the 5G system,

$${N}_{sc}^{RB} = 12 ,$$

and a data rate may increase in proportion to the number of RBs scheduled to a UE.

In the wireless communication system, a BS maps data in in units of RBs, and in general, scheduling of RBs constituting one slot may be performed for a certain UE. That is, in the 5G system, a basic time unit for performing scheduling may be a slot, and a basic frequency unit for performing scheduling may be an RB.

$${N}_{symb}^{slot}$$

that is the number of OFDM symbols is determined according to a length of a cyclic prefix (CP) added to each symbol so as to prevent interference between symbols, and for example, when a normal CP is applied, and when an extended CP is applied,

$${N}_{symb}^{slot} = 14 ,$$

and when an extended CP is applied,

$${N}_{symb}^{slot} = 12.$$

Because the extended CP is applied to a system having a relatively greater radio transmission distance than the normal CP, orthogonality between symbols may be maintained. In the case of the normal CP, a ratio of a CP length to a symbol length is maintained at a constant value, and thus, overhead due to the CP may be kept constant, regardless of subcarrier spacings. That is, when subcarrier spacing is small, the symbol length may increase, and thus, the CP length may also increase. On the contrary, when subcarrier spacing is large, the symbol length may decrease, and thus, the CP length may also decrease. The symbol length and the CP length may be inversely proportional to subcarrier spacing.

In the wireless communication system, various frame structures may be supported by adjusting subcarrier spacing so as to satisfy various services and requirements. For example, in terms of an operating frequency band, as the subcarrier spacing is greater, it is more advantageous to recover phase noise in a high frequency band. In terms of a transmission time, as the subcarrier spacing is greater, a symbol length of the time domain is shorter and a slot length is shorter, and as a result, it is more advantageous to support an ultra-low latency service such as URLLC. In terms of a cell size, as the CP length is longer, it is possible to support a large cell, and thus, as the subcarrier spacing is smaller, it is possible to support a relatively large cell. A cell indicates an area covered by one BS in mobile communication.

The subcarrier spacing, the CP length, etc. are essential information for OFDM transmission and reception, and seamless transmission and reception may be performed only when the BS and the UE recognize the subcarrier spacing, the CP length, etc. as common values.

Table 1 shows a relation between subcarrier spacing configuration (μ), subcarrier spacing (Δf), and CP length.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |

Table 2 shows the number of symbols

$$( {N}_{symb}^{slot} )$$

per slot, the number of slots

$$( {N}_{slot}^{frame , μ} )$$

per frame, and the number of slots

$$( {N}_{slot}^{subframe , μ} )$$

per subframe, for each subcarrier spacing (μ) in the case of the normal CP.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 shows the number of symbols

$$( {N}_{symb}^{slot} )$$

per slot, the number of slots

$$( {N}_{slot}^{frame , μ} )$$

per frame, and the number of slots

$$( {N}_{slot}^{subframe , μ} )$$

per subframe, for each subcarrier spacing (μ) in the case of the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At the initial stage of introduction of the 5G system, at least coexistence or dual mode operation with the legacy LTE and/or LTE-A system (hereinafter, the LTE/LTE-A system) was expected. Accordingly, the legacy LTE/LTE-A may provide a stable system operation to a UE, and the 5G system may provide improved services to the UE. Therefore, a frame structure of the 5G system may need to include at least the LTE/LTE-A frame structure or the essential parameter set (subcarrier spacing=15 kHz).

For example, comparing a frame structure where subcarrier spacing configuration μ=0 (hereinafter, frame structure A) with a frame structure where subcarrier spacing configuration μ=1 (hereinafter, frame structure B), subcarrier spacing and an RB size in frame structure B are increased twice and a slot length and a symbol length are reduced twice, compared with frame structure A. In frame structure B, 2 slots may constitute 1 subframe, and 20 subframes may constitute 1 frame.

When the frame structures of the 5G system are generalized, high expandability may be provided by making essential parameter sets such as the subcarrier spacing, the CP length, the slot length, etc. have an integer multiple relation for each frame structure Also, a subframe having a fixed length of 1 ms may be defined to indicate a reference time unit irrelevant to the frame structure.

The frame structures may be applied to correspond to various scenarios. In terms of the cell size, as the CP length is longer, a larger cell may be supported, and thus, frame structure A may support relatively large cells, compared with frame structure B. In terms of the operating frequency band, as the subcarrier spacing is greater, it is more advantageous to recover phase noise in a high frequency band, and thus, frame structure B may support a relatively high operating frequency, compared with frame structure A. In terms of the service, as the slot length that is a basic time unit of scheduling is shorter, it is more advantageous to support an ultra-low latency service such as URLLC, and thus, frame structure B may be relatively appropriate for URLLC services compared with frame structure A.

Hereinafter, in the description of the disclosure, an uplink (UL) may refer to a radio link for transmitting data or a control signal from a UE to a BS, and a downlink (DL) may refer to a radio link for transmitting data or a control signal from the BS to the UE.

In an initial access operation in which a UE initially accesses a system, the UE may synchronize DL time and frequency from a synchronization signal transmitted from a BS and may obtain cell identifier (cell ID), via cell search. Then, the UE may receive a physical broadcast channel (PBCH) by using the obtained cell ID, and may obtain, from the PBCH, a master information block (MIB) that is essential system information. In addition, the UE may receive a system information block (SIB) transmitted from the BS, and thus, may obtain cell-common transmission and reception control information from the SIB. The cell-common transmission and reception control information may include random access-associated control information, paging-associated control information, common control information with respect to various physical channels.

A synchronization signal is a signal that is a reference of cell search, and subcarrier spacing may be applied to be adapted to a channel environment such as phase noise, for each frequency band. In order for a data channel or a control channel to support various services described above, subcarrier spacing may be adaptively applied according to service types.

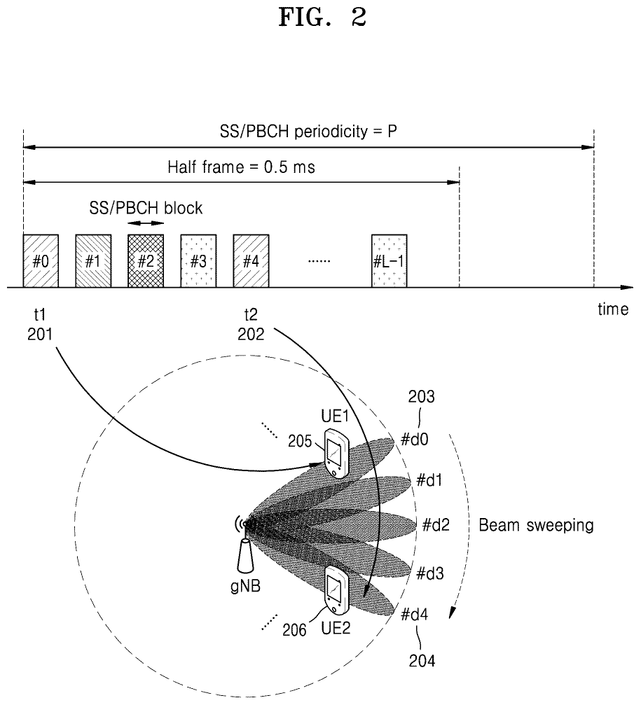

FIG. 2 illustrates a time domain mapping structure and a beam sweeping operation for a synchronization signal according to an embodiment of the disclosure.

Hereinafter, the following elements may be predefined for description of the disclosure:
Primary synchronization signal (PSS): It is a signal used as a reference for DL time/frequency synchronization and may provide partial information of a cell ID;
Secondary synchronization signal (SSS): It is used as a reference for DL time/frequency synchronization and may provide other partial information of the cell ID. The SSS may also serve as a reference signal for demodulation of a PBCH;
Physical broadcast channel (PBCH): A PBCH may provide an MIB that is essential system information needed for the UE to transmit and receive a data channel and a control channel. The essential system information may include search space-associated control information indicating radio resource mapping information of a control channel, scheduling control information of a separate data channel for transmitting system information, information such as a system frame number (SFN) that is an index in a frame level that is timing reference; and/or
SS/PBCH block (or SSB): A SS/PBCH block may consist of N OFDM symbols and may include a combination of the PSS, the SSS, and the PBCH. For a system using a beam sweeping technique, the SS/PBCH block may be the smallest unit for applying beam sweeping. In the 5G system, N=4. The BS may transmit up to L SS/PBCH blocks, and the L SS/PBCH blocks may be mapped within a half frame (0.5 ms). The L SS/PBCH blocks may be periodically repeated with a periodicity P. The BS may inform the UE of the periodicity P by signaling. When there is no separate signaling for the periodicity P, the UE may apply a predetermined default value.

FIG. 2 illustrates an example in which beam sweeping is applied in units of SS/PBCH blocks over time. In the example of FIG. 2, a first UE (UE1) 205 may receive an SS/PBCH block by using a beam emitted in direction #d0 203 due to beamforming applied to SS/PBCH block #0 at a time point t1 201. Also, a second UE (UE2) 206 may receive an SS/PBCH block by using a beam emitted in direction #d4 204 due to beamforming applied to SS/PBCH block #4 at a time point t2 202. The UE may obtain an optimal synchronization signal via a beam emitted from the BS in a direction toward a location of the UE. For example, it may be difficult for the UE1 205 to obtain time/frequency synchronization and essential system information from a SS/PBCH block via the beam emitted in the direction #d4 204 that is distant from the location of the UE1 205.

In addition to reception for the initial access procedure, the UE may receive an SS/PBCH block to determine whether a radio link quality of a current cell is maintained above a certain level. Also, in a handover procedure in which the UE moves from a current cell to a neighboring cell, the UE may receive an SS/PBCH block from the neighboring cell so as to determine a radio link quality of the neighboring cell and obtain time/frequency synchronization of the neighboring cell.

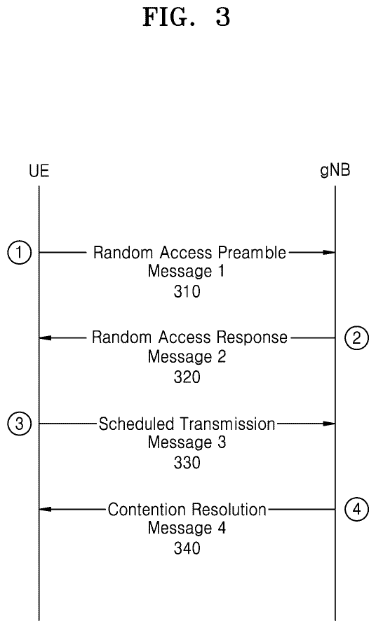

After the UE obtains an MIB and system information from the BS via the initial access procedure, the UE may perform a random access procedure to switch a link with the BS to a connected state (or RRC_CONNECTED state). Upon completion of the random access procedure, the UE transitions to a connected state or an RRC_CONNECTED state, and one-to-one communication is enabled between the BS and the UE. Hereinafter, a random access procedure will be described in detail with reference to FIG. 3.

FIG. 3 illustrates a flow of signals for random access (RA) according to an embodiment of the disclosure. FIG. 3 illustrates an example of a random access procedure, and the disclosure is not limited thereto. Also, the disclosure is not limited to a 4-step random access procedure of FIG. 3, and may also be applied to a 2-step random access procedure (transmission and reception of Message A (message including information corresponding to Message 1 and Message 3) and transmission and reception of Message B (message including information corresponding to Message 2 and Message 4)).

Referring to FIG. 3, in operation 310, a UE may transmit a random access preamble to a BS. In the random access procedure, the random access preamble, which is a first message transmitted by the UE, may be referred to as Message 1. The BS may measure a transmission delay value between the UE and the BS from the random access preamble and perform UL synchronization. In this case, the UE may randomly select a random access preamble to use from a set of random access preambles given by system information in advance. In addition, initial transmission power for the random access preamble may be determined according to a pathloss between the BS and the UE, which is measured by the UE. Also, the UE may determine a direction of a transmission beam for the random access preamble, from a synchronization signal received from the BS, and may transmit the random access preamble in the determined direction of the transmission beam.

In operation 320, the BS may transmit a random access response (RAR) (or Message 2), in response to the random access preamble received in operation 310. The BS may transmit a UL transmission timing control command to the UE, based on the transmission delay value measured from the random access preamble. The BS may transmit, to the UE, a UL resource to be used by the UE and a power control command as scheduling information. The scheduling information transmitted by the BS may include control information regarding a UL transmission beam of the UE.

When the UE does not successfully receive, from the BS, the RAR (or Message 2) that is the scheduling information for Message 3 within a certain time period in operation 320, the UE may perform operation 310 again. When the UE performs operation 310 again, the UE may transmit the random access preamble with transmission power increased by a certain step (power ramping), thereby increasing the probability of reception of the random access preamble at the BS.

In operation 330, the UE may transmit UL data (Message 3) including its UE ID to the BS by using the UL resource allocated in operation 320. The UE may transmit the UL data including the UE ID to the BS via a UL data channel (e.g., a physical UL shared channel (PUSCH)). A transmission timing of the UL data channel for transmitting Message 3 may be controlled according to the timing control command received from the BS in operation 320. Transmission power for the UL data channel for transmitting Message 3 may be determined by considering the power control command received from the BS in operation 320 and a power ramping value applied to the random access preamble. The UL data channel for transmitting Message 3 may mean a first UL data signal transmitted by the UE to the BS after the UE transmits the random access preamble.

In operation 340, when the BS determines that the UE has performed the random access procedure without colliding with another UE, the BS may transmit data (Message 4) including the ID of the UE that has transmitted the UL data in operation 330 to the UE. When the UE receives the data transmitted by the BS in operation 340, the UE may determine that the random access procedure is successful. The UE may transmit, to the BS via a UL control channel (e.g., a physical UL control channel (PUCCH)), hybrid automatic repeat request acknowledgement (HARQ-ACK) information indicating whether Message 4 has been successfully received.

When the data transmitted by the UE in operation 330 collides with data transmitted by another UE and thus the BS fails to receive a data signal from the UE, the BS may no longer transmit data to the UE. When the UE fails to receive the data transmitted by the BS in operation 340 within a certain period of time, the UE may determine that the random access procedure has failed and may restart the random access procedure from operation 310.

Upon successful completion of the random access procedure, the UE may transition to a connected state or RRC_CONNECTED state, and one-to-one communication between the BS and UE is enabled. The BS may receive UE capability information from the UE in the connected state or RRC_CONNECTED state, and may adjust scheduling based on the UE capability information of the corresponding UE. The UE may inform, via the UE capability information, the BS of whether the UE itself supports a certain function, a maximum allowable value of the function supported by the UE, etc. Accordingly, the UE capability information reported by each UE to the BS may have a different value for each UE.

For example, the UE may report, to the BS, UE capability information including at least one of the following control information as the UE capability information:
Control information associated with a frequency band supported by the UE;
Control information associated with a channel bandwidth supported by the UE;
Control information associated with a highest modulation scheme supported by the UE;
Control information associated with a maximum number of beams supported by the UE;
Control information associated with a maximum number of layers supported by the UE;
Control information associated with channel state information (CSI) reporting supported by the UE;
Control information about whether the UE supports frequency hopping;
Control information associated with a bandwidth when carrier aggregation (CA) is supported; and/or
Control information about whether cross-carrier scheduling is supported when CA is supported.

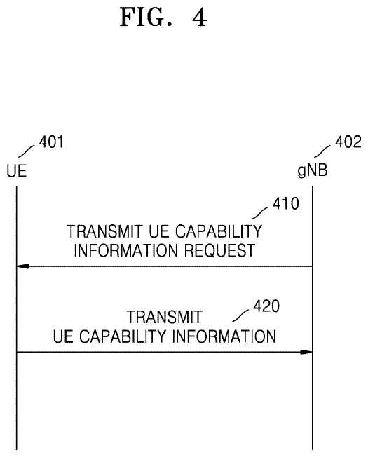

FIG. 4 illustrates a flow of signals for a UE to report UE capability information to a BS according to an embodiment of the disclosure.

Referring to FIG. 4, in operation 410, a BS 402 may transmit a message of UE capability information request to a UE 401. In response to the UE capability information request from the BS 402, the UE 401 transmits UE capability information to the BS 402 in operation 420. According to an embodiment of the disclosure, regardless of the UE capability information request from the BS 402, the UE 401 may transmit UE capability information to the BS 402.

A UE connected to a BS, based on a UE capability information transceiving procedure, may perform one-to-one communication with the BS, as the UE in an RRC_CONNECTED state. On the other hand, a UE not connected to the BS is in an RRC_IDLE state, and the UE in the RRC_IDLE state may perform a procedure below:
To perform a UE-specific discontinuous reception (DRX) cycle configured by a higher layer signaling information;
To receive a paging message from a core network;
To obtain system information;
Measurement operation associated with serving cell (or camped-on cell) and cell selection/reselection;
Measurement operation associated with neighboring cell and cell reselection; and/or
To receive paging early indication (PEI).

Higher layer signaling information in the disclosure may be signaling information corresponding to at least one or a combination of one or more of the following signaling information:
Master information block (MIB);
System information block (SIB) or SIB X (X=1, 2, . . . );
Radio resource control (RRC) information; and/or
Medium access control (MAC) control element (CE).

Also, layer 1 (L1) signaling information may be signaling information corresponding to at least one or a combination of one or more of the following physical layer channels or signaling methods using signaling:
Physical downlink control channel (PDCCH);
Downlink control information (DCI);
UE-specific DCI;
Group common DCI; and/or
Common DCI.

Also, in an embodiment of the disclosure, information transmitted and received between a BS and a UE by using higher layer signaling information may also be transmitted and received by using various combinations of higher layer signaling information and/or L1 signaling information.

In more detail with respect to the measurement operation associated with serving cell (or camped-on cell) and cell selection/reselection, the UE may measure synchronization signal-reference signal received power (SS-RSRP) and synchronization signal-reference signal received quality (SS-RSRQ) levels for at least every M1*N1 DRX cycle with respect to a serving cell (or a camped-on cell), and may evaluate cell selection determination reference S, based on the measured values. Here, M1=2 in a case where an SSB-based measurement timing configuration (SMTC) period is greater than 20 ms, and a DRX cycle is equal to or less than 0.64 s, and M1=1 in other cases.

N1 may be determined based on Table 4 below.

TABLE 4

| | N1 | | | Nₛₑᵣᵥ [number |
|---|---|---|---|---|
| DRX cycle[s] | FR1 | FR2-1 | FR2-2 | of DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination reference S may be satisfied when Sᵣₓₗₑᵥ>0 corresponding to SS-RSRP and S_{qual}>0 corresponding to SS-RSRQ.

$${S}_{rxlev} = {Q}_{rxlevmeas} - ( {Q}_{rxlevmin} + {Q}_{rxlevminoffset} ) - {P}_{compensation} - {Q}_{offsettemp} . \qquad [ Equation 1 ]$$

$$Squal = Qqualmeas - ( Qqualmin + Qqualminoffset ) - Qoffsettemp .$$

In this regard, Qᵣₓₗₑᵥₘₑₐₛ may be measured SS-RSRP, Q_{qualmeas} may be measured SS-RSRQ, Qᵣₓₗₑᵥₘᵢₙ may be a magnitude level of a reception signal which is minimally required by a serving cell and may be received by the UE via system information, and Q_{qualmin} may be a quality level of the reception signal which is minimally required by the serving cell and may be received by the UE via the system information. For parameters, reference may be made to Table 5.

TABLE 5

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2 and SIB4, additionally, if Q_{rxlevminoffsetcellSUL} IS |
| | present in SIB3 and SIB4 for the concerned cell, this cell specific offset |
| | is added to the corresponding Qrxlevmin to achieve the required |
| | minimum RX level in the concerned cell; |
| | else Qᵣₓₗₑᵥₘᵢₙ is obtained from q-RxLevMin in SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the concerned |
| | cell. |
| Q_{qualmin} | Minimum required quality level in the cell (dB). Additionally, if |
| | Q_{qualminoffsetcell} is signalled for the concerned cell, this cell specific offset |
| | is added to achieve the required minimum quality level in the |
| | concerned cell. |
| Q_{rxlevminoffset} | Offset to the signalled Qᵣₓₗₑᵥₘᵢₙ taken into account in the Srxlev |
| | evaluation as a result of a periodic search for a higher priority PLMN |
| | while camped normally in a VPLMN, as specified in TS 23.122 [9]. |
| Q_{qualminoffset} | Offset to the signalled Q_{qualmin} taken into account in the Squal |
| | evaluation as a result of a periodic search for a higher priority PLMN |
| | while camped normally in a VPLMN, as specified in TS 23.122 [9]. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when transmitting on the |
| | uplink in the cell (dBm) defined as P_{EMAX} in TS 38.101 [15]. If UE |
| | supports SUL frequency for this cell, P_{EMAX1} and P_{EMAX2} are obtained |
| | from the p-Max for SUL in SIB1 and NR-NS-PmaxList for SUL |
| | respectively in SIB1, SIB2 and SIB4 as specified in TS 38.331 [3], else |
| | P_{EMAX1} and P_{EMAX2} are obtained from the p-Max and NR-NS-PmaxList |
| | respectively in SIB1, SIB2 and SIB4 for normal UL as specified in TS |
| | 38.331 [3]. |
| P_{PowerClass} | Maximum RF output power of the UE (dBm) according to the UE |
| | power class as defined in TS 38.101-1 [15]. |

In order to determine the measured SS-RSRP, the UE may determine the SS-RSRP of the serving cell by performing filtering on at least two measurement values apart by at least the half of a DRX cycle. Also, in order to determine the measured SS-RSRQ, the UE may determine the SS-RSRQ of the serving cell by performing filtering on at least two measurement values apart by at least the half of the DRX cycle.

When the UE determines that the serving cell does not satisfy the cell selection determination reference S during Nₛₑᵣᵥ consecutive DRX cycles, the UE may start measurement of all neighboring cells except for the serving cell. When the UE does not find a new appropriate cell for 10 s, a cell reselection procedure for a selected public land mobile network (PLMN) may start.

In more detail with respect to the measurement operation associated with neighboring cell and cell reselection, when the UE determines that the serving cell does not satisfy the cell selection determination reference S during Nₛₑᵣᵥ consecutive DRX cycles, the UE may start measurement of all neighboring cells except for the serving cell. When the UE does not find a new appropriate cell for 10s, a cell reselection procedure for a selected public land mobile network (PLMN) may start.

After the UE starts measurement of the neighboring cells, the UE may measure SS-RSRP and SS-RSRQ levels for every Tₘₑₐₛᵤᵣₑ, and may evaluate whether the neighboring cells satisfy a cell reselection determination reference within every Tₑᵥₐₗᵤₐₜₑ. The UE may evaluate whether a newly-detected cell satisfies a cell reselection determination reference within every T_{detect}. In a case where a neighboring cell is better than the serving cell within T_{reselection}, according to the cell reselection determination reference, and at the same time, at least 1 second has passed after the UE camped on the current serving cell, the UE may reselect the neighboring cell as a new serving cell. In this regard, the parameters such as Tₘₑₐₛᵤᵣₑ, Tₑᵥₐₗᵤₐₜₑ, T_{reselection}, etc. may be determined from the rules according to a DRX cycle, or may be configured by a higher layer signal. In order to determine the measured SS-RSRP, the UE may determine the SS-RSRP of the neighboring cell by performing filtering on at least two measurement values apart by at least the half of Tₘₑₐₛᵤᵣₑ.

The cell reselection determination reference may determine cell selection priorities, based on Rₛ and Rₙ which are calculated by parameters below. For example, a cell ranking may be determined in order of high values among Rₛ and Rₙ.

$${R}_{s} = {Q}_{meas , s} + {Q}_{hyst} - {Qoffset}_{temp} .$$

$${R}_{n} = {Q}_{meas , n} - Qoffset - {Qoffset}_{temp} .$$

Here, Q_{meas,s} and Q_{meas,n} may respectively indicate RSRP measurement values of a serving cell and neighboring cells, and Q_{hyst}, Qoffset, Qoffsetₜₑₘₚ may be configured by a higher layer signal.

In relation to neighboring cell measurement, when a specific condition is satisfied, the neighboring cell measurement may be stopped or may be performed with a period longer than the Tₘₑₐₛᵤᵣₑ. According to an embodiment of the disclosure, when the UE moves with a low speed or stops within a cell or determines that the UE is not present at a cell boundary, the UE may perform the neighboring cell measurement with a long period obtained by multiplying Tₘₑₐₛᵤᵣₑ by a scaling factor or may stop the neighboring cell measurement during up to 1 hour.

In more detail with respect to the reception of paging message from the core network, a UE (i.e., the UE including only a main radio) may monitor one paging occasion (PO) during a DRX cycle. A PO is a set of PDCCH monitoring occasions and may include a plurality of time slots (e.g., subframes or OFDM symbols) where paging control information may be received. A paging frame (PF) is one radio frame (10 ms) and may include one or more POs or starting point of a PO.

The PF and the PO may be determined based on Equation 2.

$$( SFN + PF\_offset ) mod T = ( T div N ) * ( UE\_ID mod N ) . \qquad [ Equation 2 ]$$

A system frame number (SFN) for a PF may be determined based on Equation 2, PF_offset is an offset for PF determination, T is a DRX cycle, N is the number of (cell-specific) PFs per DRX cycle and is determined by higher layer signaling information, and UE_ID is a UE ID (5G-S-temporary mobile subscriber identity (TMSI)) and is determined by a core network. The PFs determined by the N refer to paging frames commonly applied to UEs within a cell, and are referred to as cell-specific PFs in the disclosure.

i_s indicating a PO index is determined based on Equation 3.

$$i\_s = floor ( UE\_ID / N ) mod Ns . \qquad [ Equation 3 ]$$

Here, Ns denotes the number of POs in one PF, is one of integer values such as 1, 2, 4, . . . , and is determined by higher layer signaling information.

For example, when it is assumed that PF_offset=3, T=128, N=T/4=32, Ns=4, and UE_ID is expressed as UE_ID mod 32=1 and floor (UE_ID/32) mod 4=1, an SFN for the PF and i_s indicating a PO index in the PF in Equation 2 and Equation 3 may be determined as follows.

$$( SFN + 3 ) mod 128 = ( 128 div 32 ) * ( UE\_ID mod 32 ) = 4 * 1 = 4 ,$$

$$i\_s = floor ( UE\_ID / 32 ) mod 4 = 1.$$

Accordingly, the PF, which is a paging frame that the UE with the UE_ID may receive may be determined to be a radio frame with SFN values of 1, 129, 257, . . . among the cell-common PFs (cell specific PFs), and the PO may be determined to be a (i_s+1)^{th} PO (e.g., a second PO in the above example) among four POs in the PF. The PO refers to a set of PDCCH monitoring occasions (e.g., “S×X” consecutive PDCCH monitoring occasions). Here, “S” is the number of actually transmitted SSBs determined according to ssb-positionsinburst information indicating time domain positions of SSB(s) transmitted in a half frame including SS/PBCH blocks, provided through RRC information in the NR standard, and “X” may be typically “1.”

Next, in more detail with respect to the reception of paging early indication (PEI), PEI was introduced to reduce UE power consumption that results from monitoring and receiving a paging control channel and a paging data channel during each DRX cycle. A UE may monitor or receive one PEI occasion (PEI-O) before receiving paging during a DRX cycle. When the UE receives PEI and the PEI indicates a paging reception subgroup to which the UE belongs, the UE may monitor an associated PO. When the UE does not detect PEI or the PEI does not indicate a paging reception subgroup to which the UE belongs, the UE does not need to monitor an associated PO, thereby reducing UE power consumption. The UE may determine a PEI-O by using the following method. A PEI-O is located behind by a subframe offset based on a radio frame of a reference point, which is located prior to a PF including an associated PO by pei-FrameOffset, and the UE may monitor the PEI in the PEI-O determined by using the method. The pei-FrameOffset, the subframe offset, etc. may be determined by higher layer signaling information.

A UE in a new state referred to as RRC_INACTIVE is defined so as to reduce energy and time consumed for initial access by the UE in the 5G system. The UE in RRC_INACTIVE may perform operations below, in addition to operations performed by the UE in RRC_IDLE:
To store access stratum (AS) information for cell access;
To perform a UE-specific DRX cycle operation configured by an RRC layer;
To configure and periodically update a perform radio access network (RAN)-based notification area (RNA) that may be used for handover by an RRC layer; and/or
To monitor a RAN-based paging message transmitted through an inactive-radio network temporary identifier (I-RNTI).

A UE in an RRC_CONNECTED state may receive an RRC Release indication from a BS, and thus, may transition from the RRC_CONNECTED state to an RRC_INACTIVE or RRC_IDLE state.

The UE in the RRC_INACITVE or RRC_IDLE state may perform random access and complete all random access procedures, and thus, may transition from the RRC_INACTIVE or RRC_IDLE state to the RRC_CONNECTED state.

Hereinafter, a scheduling method by which a BS transmits DL data to a UE or indicates UL data transmission performed by the UE will now be described.

Downlink control information (DCI) may be control information transmitted by the BS to the UE via a DL. DCI may include DL data scheduling information or UL data scheduling information for a certain UE. In general, the BS may independently channel-code DCI for each UE and then may transmit it to a corresponding UE via a physical downlink control channel (PDCCH) that is a physical control channel for DL.

The BS may apply and operate a predefined DCI format for a UE to be scheduled according to purposes such as whether DCI carries scheduling information for DL data (DL assignment), whether the DCI carries scheduling information for UL data (UL grant), whether the DCI is DCI for power control, etc.

The BS may transmit DL data to the UE via a physical downlink shared channel (PDSCH) that is a physical channel for DL data transmission. The BS may inform the UE of scheduling information, such as a specific mapping location of the PDSCH in the time-frequency domain, a modulation scheme, hybrid automatic repeat request (HARQ)-associated control information, power control information, etc., via DCI related to DL data scheduling information among DCIs transmitted on the PDCCH.

The UE may transmit UL data to the BS via a physical uplink shared channel (PUSCH) that is a physical channel for UL data transmission. The BS may inform the UE of scheduling information, such as a specific mapping location of the PUSCH in the time-frequency domain, a modulation scheme, HARQ-associated control information, power control information, etc., via DCI related to UL data scheduling information among DCIs transmitted on the PDCCH.

Time-frequency resources on which a PDCCH is mapped may be referred to as a control resource set (CORESET). The CORESET may be configured in all or some frequency resources of a bandwidth supported by a UE in a frequency domain. The CORESET may be configured with one or more OFDM symbols in a time domain, and may be defined by a control resource set duration. A BS may configure the UE with one or more CORESETs by higher layer signaling (e.g., system information, master information block (MIB), or radio resource control (RRC) signaling). When the CORESET is configured for the UE, it may mean that the BS provides the UE with information such as a CORESET ID, a frequency location of the CORESET, and a symbol length of the CORESET. A plurality of pieces of information provided from the BS to the UE so as to configure a CORESET may include at least some of information included in Table 6.

```
TABLE 6
ControlResourceSet ::= SEQUENCE {
controlResourceSetId ControlResourceSetId,
(CORESET Identifier)
frequencyDomainResources BIT STRING (SIZE (45)),
(Frequency domain resource)
duration INTEGER (1..maxCoReSetDuration),
(CORESET duration)
cce-REG-MappingType CHOICE {
(CCE-to-REG mapping type)
  interleaved SEQUENCE {
  reg-BundleSize ENUMERATED {n2, n3, n6},
    (REG bundle size)
    interleaverSize ENUMERATED {n2, n3, n6},
    (Interleaver size)
    shiftIndex INTEGER(0..maxNrofPhysicalResourceBlocks−1) OPTIONAL --
Need S
    (Interleaver shift)
  },
  nonInterleaved NULL
},
precoderGranularity ENUMERATED {sameAsREG-bundle, allContiguousRBs},
(Precoding unit)
tci-StatesPDCCH-ToAddList SEQUENCE(SIZE (1..maxNrofTCI-StatesPDCCH)) OF
TCI-StateId OPTIONAL, -- Cond NotSIB1-initialBWP
(QCL configuration information)
tci-StatesPDCCH-ToReleaseList SEQUENCE(SIZE (1..maxNrofTCI-StatesPDCCH))
OF TCI-StateId OPTIONAL, -- Cond NotSIB1-initialBWP
(QCL configuration information)
```

| | |
|---|---|
| tci-PresentInDCI ENUMERATED {enabled} | OPTIONAL, -- Need S |

(QCL indicator configuration information in DCI)

| | |
|---|---|
| pdcch-DMRS-ScramblingID INTEGER (0..65535) | OPTIONAL, -- Need S |

(PDCCH DMRS scrambling identifier)
}

A CORESET may consist of

$${N}_{RB}^{CORESET}$$

RBs in a frequency domain and may consist of

$${N}_{RB}^{CORESET}$$

∈{1,2,3} symbols in a time domain. An NR PDCCH may consist of one or more control channel elements (CCEs). One CCE may include 6 resource element groups (REGs), and each REG may be defined as one RB during one OFDM symbol. REGs in one CORESET may be indexed in a time-first manner, starting with 0 for a first OFDM symbol and a lowest-numbered RB in the CORESET.

An interleaving method and a non-interleaving method may be supported as a method of transmitting a PDCCH. A BS may configure a UE as to whether to perform interleaving transmission or non-interleaving transmission for each CORESET by higher layer signaling. Interleaving may be performed in units of REG bundles. The term “REG bundle” may be defined as a set of one or more REGs. The UE may determine a CCE-to-REG mapping method in the CORESET by using the following method as in Table 7 based on whether to perform interleaving or non-interleaving transmission configured from the BS.

```
TABLE 7
The CCE-to-REG mapping for a control-resource set can be interleaved or non-interleaved
and is described by REG bundles:
  REG bundle i is defined as REGs {iL, iL + 1, ... , iL + L − 1} where L is the REG
  $bundle size , i = 0 , 1 , ... , {N}_{REG}^{CORESET} / L - 1 and {N}_{REG}^{CORESET} = {N}_{RB}^{CORESET} {N}_{symb}^{CORESET} is$
  the number of REGs in the CORESET
  CCE j consists of REG bundles {f(6j/L), f(6j/L + 1), ... , f(6j/L + 6/L − 1)}
  where f (·)is an interleaver
For non-interleaved CCE-to-REG mapping, L = 6 and f(x) = x.
$For interleaved CCE - to - REG mapping , L ∈ \{ 2 , 6 \} for {N}_{symb}^{CORESET} = 1 and L ∈ \{ {N}_{symb}^{CORESET} , 6 \}$
$for {N}_{symb}^{CORESET} ∈ \{ 2 , 3 \} . The interleaver is defined by$
$f ( x ) = ( rC + c + {n}_{shift} ) mod ( {N}_{REG}^{CORESET} / L ) C = {N}_{REG}^{CORESET} / ( LR ) 〈 〈 mth 2 〉 〉 x = cR + r$
r = 0, 1, ... , R − 1
c = 0, 1, ... , C − 1
where R ∈ {2, 3, 6}.
```

The BS may inform, by signaling, the UE of information about a symbol to which a PDCCH is mapped within a slot, configuration information such as transmission periodicity, or the like.

A search space of the PDCCH will now be described. The number of CCEs required to transmit the PDCCH may be 1, 2, 4, 8, or 16 depending on an aggregation level (AL), and different numbers of CCEs may be used to implement link adaptation of the DL control channel. For example, when AL=L, one DL control channel may be transmitted in L CCEs. The UE performs blind decoding to detect a signal without knowing information about the DL control channel, and thus, a search space representing a set of CCEs may be defined for the blind decoding. The search space may be defined as a set of DL control channel candidates that include CCEs on which the UE needs to attempt decoding at a given AL, and because there are various ALs each making a bundle with 1, 2, 4, 8, or 16 CCEs, the UE may have a plurality of search spaces. A search space set may be defined as a set of search spaces at all the configured ALs.

The search spaces may be classified into a common search space (CSS) and a UE-specific search space (USS). A certain group of UEs or all the UEs may monitor a common search space of the PDCCH so as to receive dynamic scheduling of the system information (system information block (SIB)) or receive cell-common control information such as a paging message. For example, the UE may monitor a CSS of the PDCCH so as to receive PDSCH scheduling allocation information for receiving system information. Because a certain group of UEs or all the UEs need to receive the PDCCH, the common search space may be defined as a set of predefined CCEs. The UE may receive UE-specific PDSCH or PUSCH scheduling allocation information by monitoring a USS of the PDCCH. The USS may be UE-specifically defined as a function of various system parameters and an ID of the UE.

A BS may configure a UE with configuration information about a search space of a PDCCH by higher layer signaling (e.g., SIB, MIB, or RRC signaling). For example, the BS may configure the UE with the number of PDCCH candidates at each AL, a monitoring periodicity for the search space, a monitoring occasion on symbols in a slot for the search space, a type of the search space (CSS or USS), a combination of a DCI format to be monitored in the search space and a radio network temporary identifier (RNTI), a CORESET index to monitor the search space, or the like. For example, a parameter with respect to the search space of the PDCCH may include a plurality of pieces of information as in Table 8 below.

TABLE 8

| | |
|---|---|
| SearchSpace ::= | SEQUENCE { |
| searchSpaceId | SearchSpaceId, |

```
          (Search space identifier)
  controlResourceSetId  ControlResourceSetId  OPTIONAL, -- Cond SetupOnly
          (CORESET identifier)
  monitoringSlotPeriodicityAndOffset CHOICE {
          (Monitoring slot level periodicity and offset)
```

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl180 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |
| } | OPTIONAL, -- Cond Setup |

```
  duration  INTEGER (2..2559)  OPTIONAL, -- Need R
          (Monitoring duration)
  monitoringSymbolsWithinSlot BIT STRING (SIZE (14)) OPTIONAL, -- Cond Setup
          (Monitoring symbol position within slot)
```

| | |
|---|---|
| nrofCandidates | SEQUENCE { |

(Number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| } | OPTIONAL, -- Cond Setup |
| searchSpaceType | CHOICE { |

(Search space type)

| | |
|---|---|
| common | SEQUENCE { |
| | (Common search space) |

```
    dci-Format0-0-AndFormat1-0 SEQUENCE {
      ...
```

| | |
|---|---|
| } | OPTIONAL, -- Need R |
| dci-Format2-0 | SEQUENCE { |
| nrofCandidates-SFI | SEQUENCE { |
| aggregationLevel1 | ENUMERATED {n1, n2} OPTIONAL, -- Need R |
| aggregationLevel2 | ENUMERATED {n1, n2} OPTIONAL, -- Need R |
| aggregationLevel4 | ENUMERATED {n1, n2} OPTIONAL, -- Need R |
| aggregationLevel8 | ENUMERATED {n1, n2} OPTIONAL, -- Need R |
| aggregationLevel16 | ENUMERATED {n1, n2} OPTIONAL -- Need R |

```
      },
      ...
```

| | |
|---|---|
| } | OPTIONAL, -- Need R |
| dci-Format2-1 | SEQUENCE { |

...

| | |
|---|---|
| } | OPTIONAL, -- Need R |
| dci-Format2-2 | SEQUENCE { |

...

| | |
|---|---|
| } | OPTIONAL, -- Need R |
| dci-Format2-3 | SEQUENCE { |
| dummy1 | ENUMERATED {sl1, s12, sl4, s15, s18, s110, sl16, s120} OPTIONAL, -- Cond |

Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |
| | (UE-specific search space) |
| dci-Formats | ENUMERATED {formats0-0-And-1-0, formats0-1-And-1-1}, |

```
    ...,
    }
```

| | |
|---|---|
| } | OPTIONAL -- Cond Setup2 |

}

Based on the configuration information transmitted to the UE, the BS may configure the UE with one or more search space sets. According to an embodiment of the disclosure, the BS may configure search space set 1 and search space set 2 for the UE. The BS may configure the UE to monitor DCI format A scrambled by an X-RNTI in the search space set 1 in the CSS and to monitor DCI format B scrambled by a Y-RNTI in the search space set 2 in the USS.

Based on the configuration information transmitted from the BS, one or more search space sets may be present in the CSS or the USS. For example, search space set #1 and search space set #2 may be configured as the CSS, and search space set #3 and search space set #4 may be configured as the USS.

In the CSS, the UE may monitor combinations of DCI formats and RNTIs below. According to various embodiments of the disclosure, the combinations are not limited to examples below:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

In the USS, the UE may monitor combinations of DCI formats and RNTIs below. According to various embodiments of the disclosure, the combinations of DCI formats and RNTIs that the UE monitors are not limited to examples below:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

The RNTIs may conform to definitions and purposes below. According to various embodiments of the disclosure, the definitions and the purposes of the RNTIs are not limited to examples below:
Cell RNTI (C-RNTI): For scheduling UE-specific PDSCH or PUSCH;
Temporary cell RNTI (TC-RNTI): For scheduling UE-specific PDSCH;
Configured scheduling RNTI (CS-RNTI): For scheduling semi-statically configured UE-specific PDSCH;
Random access RNTI (RA-RNTI): For scheduling PDSCH during random access;
Paging RNTI (P-RNTI): For scheduling PDSCH where paging is transmitted;
System information RNTI (SI-RNTI): For scheduling PDSCH where system information is transmitted;
Interruption RNTI (INT-RNTI): For notifying whether PDSCH is punctured;
Transmit power control for PUSCH RNTI) (TPC-PUSCH-RNTI): For indicating power control command for PUSCH;
Transmit power control for PUCCH RNTI (TPC-PUCCH-RNTI): For indicating power control command for PUCCH; and/or
Transmit power control for SRS RNTI (TPC-SRS-RNTI): For indicating power control command for SRS.

The DCI formats described above may conform to definitions as in Table 9 below.

TABLE 9

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

A search space at an aggregation level L with a CORESET p and a search space set s may be represented as in Equation 4 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad [ Equation 4 ]$$

L: aggregation level;
n_{CI}: carrier index;
N_{CCE,p}: total number of CCEs existing in control resource set p;

$${n}_{s , f}^{μ} : slot index ; {M}_{p , s , max}^{( L )} ;$$

number of PDCCH candidates of aggregation level L;
m_{snCI}=0, . . . . M^{(L)}_{p,x,max}−1: PDCCH candidates indices of aggregation level L;
i=0, . . . , L−1;

$${Y}_{p , {n}_{s , f}^{μ}} = ( {A}_{p , {n}_{s , f}^{μ} - 1} ) mod D , {Y}_{p , - 1} = {n}_{RNTI} \neq 0 ,$$

$${A}_{0} = 39827 , {A}_{1} = 39829 , {A}_{2} = 39839 , D = 65537 ;$$

and
n_{RNTI}: UE identifier.

A value

$${Y}_{p , {n}_{s , f}^{μ}}$$

may correspond to 0 in the case of a common search space.

The value

$${Y}_{p , {n}_{s , f}^{μ}}$$

may correspond to a value that varies according to UE ID (C-RNTI or ID configured for UE by BS) and a time index in the case of a UE-specific search space.

In a cell operating TDD, a BS may transmit or receive, to or from an existing TDD terminal, a signal including data/control information in a DL slot (or symbol), a UL slot (or symbol), and a flexible slot (or symbol), based on configuration of TDD UL-DL resource configuration information indicating a DL slot (or symbol) resource and a UL slot (or symbol) resource of the TDD. The configuration may be received by the UE by using system information or RRC.

It may be assumed that a DDDSU slot format is configured according to the TDD UL-DL resource configuration information. Here, “D” is a slot composed entirely of DL symbols, “U” is a slot composed entirely of UL symbols, and “S” is a slot that is not “D” or “U,” that is, a slot including DL symbols or UL symbols or including flexible symbols. Also, the DDDSU slot format may be repeated according to the TDD UL-DL resource configuration information. That is, a repetition period of the TDD configuration is 5 slots (5 ms for 15 kHz SCS, and 2.5 ms for 30 kHz SCS). Whether the flexible symbols may be used as DL or UL symbols may be additionally indicated to the UE by DCI format 2_0 described above. The TDD UL-DL resource configuration may be repeated according to TDD periodicity. A slot unit or a symbol unit may be configured as cell-specific information together with periodicity configuration. Hereinafter, embodiments of the disclosure will be described in detail with reference to the accompanying drawings. Hereinafter, a base station is an entity that allocates resources to a UE, and may be at least one of a next-generation node B (gNode B/gNB), an evolved node B (eNode B/eNB), a Node B, a base station (BS), a radio access unit, a BS controller, or a node on a network. A terminal may include a UE, a mobile station (MS), a cellular phone, a smartphone, a computer, or a multimedia system capable of performing a communication function. Although the following embodiments will focus on the 5G system as an example, they may be equally applied to other communication systems with similar technical backgrounds or channel types. For example, they may be applied to LTE or LTE-A mobile communication and future mobile communication technologies beyond 5G. Therefore, the embodiments of the disclosure may also be applied to other communication systems through partial modification at the discretion of one of ordinary skill in the art without greatly departing from the scope of the disclosure. For example, the disclosure may be applied to frequency division duplex (FDD), time division duplex (TDD), cross division duplex (XDD) systems, and subband full duplex (SBFD) systems.

Also, in the following description of the disclosure, detailed descriptions of well-known functions and configurations in the art may be omitted when it is deemed that they may unnecessarily obscure the essence of the disclosure. The terms used herein are those defined in consideration of functions in the disclosure, and may vary according to the intention of users or operators, precedents, etc. Hence, the terms used herein should be defined based on the meaning of the terms together with the descriptions throughout the specification.

In describing the disclosure, higher layer signaling (upper signal or upper layer signaling) may be signaling corresponding to at least one or a combination of one or more of the following signaling:
Master information block (MIB);
System information block (SIB) or SIB X (X=1, 2, . . . );
Radio resource control (RRC); and/or
Medium access control (MAC) control element (CE).

Also, layer 1 (L1) signaling may be signaling corresponding to at least one or a combination of one or more of the following physical layer channels or signaling methods using signaling:
Physical downlink control Channel (PDCCH);
Downlink control information (DCI);
UE-specific DCI;
Group common DCI;
Common DCI;
Scheduling DCI (e.g., DCI used for scheduling DL or UL data);
Non-scheduling DCI (e.g., DCI not used for scheduling DL or UL data);
Physical uplink control channel (PUCCH); and/or
Uplink control information (UCI).

Hereinafter, the above examples will be described in the disclosure through a plurality of embodiments, but the embodiments are not independent and one or more embodiments may be applied simultaneously or in combination.

In the description of an embodiment of the disclosure, an operation of a main radio may be understood as an operation of a UE including the main radio and/or an operation of a processor included in the UE including the main radio.

In the description of an embodiment of the disclosure, an operation of a wake-up receiver may be understood as an operation of a UE including the wake-up receiver and/or an operation of a processor included in the UE including the wake-up receiver.

In the description of an embodiment of the disclosure, unless specifically stated otherwise, a main radio and/or a wake-up receiver may be used for signal/channel transmission and reception of a UE.

In the description of an embodiment of the disclosure, turning on may include both transitioning from an off state to an on state and maintaining the on state.

In the description of an embodiment of the disclosure, turning off may include both transitioning from an on state to an off state and maintaining the off state.

In the description of an embodiment of the disclosure, less than (or less than a specific value) may be replaced with less than or equal to, and less than or equal to may be replaced with less than.

In the description of an embodiment of the disclosure, greater than (or greater than a specific value) may be replaced with greater than or equal to, and greater than or equal to may be replaced with greater than.

In the description of an embodiment of the disclosure, a/b may denote at least one of a or b.

As described above, in order to achieve an ultra high speed service with several Gbps in the 5G system, signal transmission and reception in an ultra-wide bandwidth of tens to hundreds of MHz or several GHz may be supported. The signal transmission and reception in the ultra-wide bandwidth may be supported via a signal component carrier or a carrier aggregation (CA) technology of combining several component carriers. When a mobile communication provider is not able to ensure, over a signal component carrier, a frequency with a bandwidth enough to provide an ultra high speed data service, the CA technology may enable the ultra high speed data service by increasing a total sum of a frequency bandwidth by combining component carriers with relatively small bandwidth sizes.

The 5G system is designed and developed for various use cases. Energy efficiency of a UE is very important in the 5G system, as well as latency, reliability, and availability. A UE in the 5G system has to charge weekly or daily, according to a user's use time, and generally consumes tens of mW in RRC_IDLE/RRC_INACTIVE state, and hundreds of mW in an RRC_CONNECTED state. A design to increase a battery lifetime may be an essential factor not only for improving a user experience but also for increasing energy efficiency. The energy efficiency may be more important for a terminal without a continuous energy source (e.g., terminal that uses a small chargeable and single coin cell battery). In 5G use cases, a sensor and an actuator are broadly arranged for monitoring, measurement, charging, etc., and in general, their batteries are not rechargeable and may be required to last for at least several years. Also, a wearable device may include a smartwatch, a ring, an eHealth-related device, a medical monitoring device, etc., and in general, it is difficult for the wearable device to last for up to 1 or 2 weeks, according to a usage time.

Power consumption of a 5G UE depends on set duration of wake-up periods (e.g., a paging cycle), and an extended discontinuous reception (eDRX) cycle with a large value may be used to satisfy a battery lifetime condition. However, as a battery lifetime lasts long, based on high latency, in the eDRX scheme, the eDRX scheme is not appropriate for a service with low latency. For example, in a use case of fire detection and extinguishment, fire shutters may need to be closed and sprinklers may need to be turned on by an actuator within one or two seconds from a time when fire is detected by a sensor. In this case, latency may be important, and thus, a long eDRX cycle is not appropriate because it cannot satisfy a latency condition.

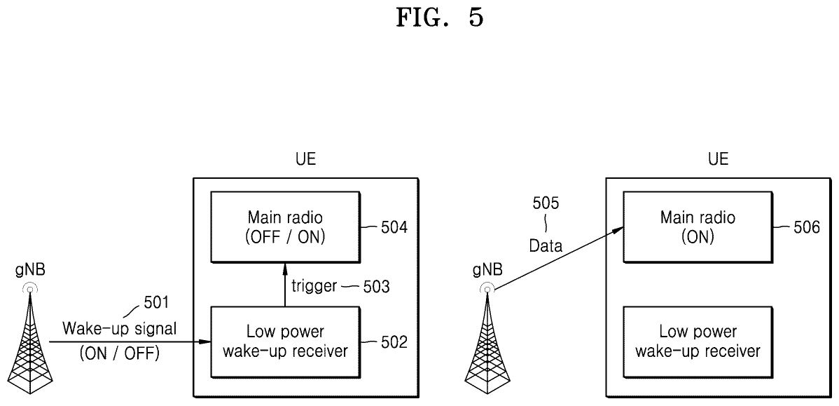

FIG. 5 illustrates an example of state switching of a BS and a UE, and a state of a UE according to a state of a BS according to an embodiment of the disclosure. In detail, FIG. 5 illustrates state switching of a BS and a UE, for solving the aforementioned problems. Various modifications may be made to a method illustrated in FIG. 5. For example, although the method is shown as a series of operations, various operations in each drawing may overlap, may be performed in parallel, may be performed in a different order, or may be performed several times. In another example, some operations may be omitted or replaced by other operations.

According to an embodiment of the disclosure, a 5G UE may need a periodic wake-up once per an eDRX cycle, and this may dominate power consumption of a period in which signaling or data traffic does not occur. When the UE may wake up only when the UE is triggered, as paging, power consumption may be significantly reduced. The significant power consumption may be achieved in a manner that a main radio (e.g., an NR radio) is triggered by using a wake-up signal (WUS) as shown in FIG. 5, and the main radio is turned on by using a wake-up receiver (WUR) only when data transceiving is performed, the WUR being a separate receiver for monitoring a WUS with ultra-low power. The main radio and the WUR may include at least one of a transceiver included in a UE and configured to transmit and receive a wireless signal, a modem for encoding/decoding of a transmitted/received signal, or components that consume power within the UE. Alternatively, the main radio and the WUR may be understood as a UE itself, and in this case, the UE may operate to consume only minimum power for receiving a WUS until the WUS is received. In the disclosure, the terms “main UE” and “transceiver” may be interchangeably used with the term “main radio.”

According to an embodiment of the disclosure, in operation 501, a BS may transmit a WUS corresponding to ON or OFF to a UE. The BS may transmit the WUS to the UE, and the WUS may include ON information or OFF information. The WUS indicating ON may trigger an on state in which the main radio operates, and the WUS indicating OFF may trigger an off state in which the main radio does not operate (or operates minimally). In an optional embodiment of the disclosure, the WUS may indicate an ON state in which the main radio operates, and the UE that receives paging by receiving the WUS may perform an operation according to the paging and then may switch the main radio back to an OFF state even without receiving the WUS or a separate signal indicating the OFF state of the main radio.

In operation 502, the UE may receive the WUS by using a wake-up receiver (WUR) or a low power WUR.

In operation 503, the UE may trigger the main radio to an OFF or ON state based on information indicating that the received WUS corresponds to ON or OFF. For example, triggering the main radio may mean triggering state switching for the main radio. For example, triggering the main radio may be triggering by switching the main radio from an OFF state to an ON state or switching the main radio from an ON state to an OFF state.

In operation 504, the UE may wake up the main radio or set a state in which power is turned off based on the WUS. For example, setting the main radio to a power-off state may mean that the main radio is completely turned off. According to an embodiment of the disclosure, the UE may set the main radio to a deep sleep (DS) or ultra deep sleep (UDS) state, rather than a completely OFF state, based on the WUS.

Whether the main radio is in a completely OFF state, a DS state, or a UDS state may be distinguished by which components in the main radio may be turned off. For example, when the main radio is in a completely OFF state, all components in the main radio may be OFF. When the main radio is in a DS state, an oscillator, a radio frequency-front end (RF-FE), and a baseband modem may be OFF, while a control processor and a double data rate (DDR) memory may still be ON. When the main radio is in a UDS state, the oscillator, the RF-FE, and the baseband modem may be OFF, and the control processor and the DDR memory may operate at very low power or be OFF. Power consumption in the main radio decreases in the order of DS state=>UDS state=>OFF state.

In operation 505, when the BS has data traffic to be transmitted to the UE, and thus, the WUS transmitted from the BS in operation 501 is a signal corresponding to ON, in operation 506, the main radio may be ON, and the UE may receive data transmitted from the BS via the main radio, not the WUR. That is, when the BS transmits the WUS corresponding to ON in operation 501, the main radio of the UE may be ON. In operation 505, the BS may transmit data, and in operation 506, the UE may receive the data through the main radio.

According to an embodiment of the disclosure, as power consumption for monitoring a WUS depends on a design of the WUS, and a hardware module of a WUR used in signal detecting and processing, a gain may be maximized for Internet of things (IoT) use cases (industrial sensors and controllers) and small form factor devices including wearable devices which are sensitive to power.

According to an embodiment of the disclosure, a UE including a WUR may report to a BS that the UE is capable of waking up a main radio by using the WUR or may report to the BS capability information indicating that the UE includes the WUR.

The UE according to an embodiment of the disclosure may report to the BS capability information about a WUR via a UE capability information report procedure of FIG. 4.

Referring to FIG. 4, a UE receiving a UE capability information request from a BS in operation 410 may transmit UE capability information including capability information about a WUR to a BS in operation 420. The UE according to an embodiment of the disclosure may provide the capability information about the WUR to the BS even when there is no request from the BS in operation 410.

The UE according to an embodiment of the disclosure may report to the BS the capability information about the WUR through at least one of operation 310 of transmitting a random access preamble in a random access procedure of operations 310 to 340 of FIG. 3 or operation 330 of transmitting a scheduled transmission (Message 3) according to the random access procedure in a UL data channel.

According to an embodiment of the disclosure, random access preamble sets that the UE including the WUR may transmit may be transmitted to the UE via higher layer signaling information. The UE may select a random access preamble from the sets that the UE receives, and may transmit the random access preamble in operation 310, based on the selected random access preamble.

According to an embodiment of the disclosure, after the UE reports the capability information about the WUR to the BS, the UE may receive information indicating whether to use the WUR, from the BS, by higher layer signaling or L1 signaling information.

When the BS according to an embodiment of the disclosure supports the UE including the WUR (e.g., when the BS has hardware capable of transmitting a WUS), the BS may receive the capability information about the WUR from the UE and then may determine whether to use the WUR.

The BS according to an embodiment of the disclosure may transmit, to the UE, a signal indicating whether to use the WUR or configuration information for reception of a WUS through higher layer signaling information and/or L1 signaling information.

The BS according to an embodiment of the disclosure may transmit, to the UE, at least one of WUS reception by the UE or indication information for activating the WUR or indication information indicating WUS transmission by the BS. After a BS-configured (or defined in the rules) slot from a slot in which the signal is received, the UE may turn off the main radio or may turn on the WUR for monitoring a WUS. The UE according to an embodiment of the disclosure may transmit, to the BS, at least one of feedback information indicating that a WUS indicating whether to use the WUR has been received before the UE turns off the main radio, or feedback information indicating that the WUR has been turned on after the UE turns off the main radio.

When the BS according to an embodiment of the disclosure does not support the UE including the WUR, the BS may receive the capability information about the WUR from the UE and then may transmit, to the UE, a signal indicating that the use of the WUR is not available. In this case, the UE according to an embodiment of the disclosure may transmit, to the BS, a feedback indicating that the signal indicating that the use of the WUR is not available is received. The UE according to an embodiment of the disclosure may perform an operation due to parameters of a power saving method configured by the BS using the power saving method (C-DRX or I-DRX such as paging) proposed in the 3GPP standard.

The UE according to an embodiment of the disclosure may determine whether to activate or deactivate the WUR, based on reception of a WUS transmitted from the BS.

The UE according to an embodiment of the disclosure may determine whether to activate or deactivate a WUR, based on reception of a synchronization signal for the WUR transmitted from the BS. The expression “based on reception of a signal” means that determination is made based on a metric value such as a reception error rate of the signal or a result value obtained by measuring the quality of the signal, and the determination may be performed through comparison with a specific value defined in the standard or with a threshold value received through a higher layer signal from the BS.

After the WUR is activated, the WUR may continuously or discontinuously monitor a WUS. When continuously monitoring a WUS, the WUR of the UE may always be in an on state. When discontinuously monitoring a WUS, the WUR of the UE may be repeated in an off state and an on state. The UE may receive, from the BS, through a higher layer signal, period and offset configuration (in a time domain) in which monitoring of a WUS through the WUR may be performed or period and offset configuration (in a time domain) in which the WUR may be in an on state. When the period and offset configuration is not present or is not received from the BS, the UE may determine to continuously monitor a WUS.

According to an embodiment of the disclosure, after a procedure for capability report by the UE including the WUR and reception of information indicating whether the WUR is supported (or allowed) by the BS, the WUR of the UE according to an embodiment of the disclosure may perform an operation of turning on or off the main radio of the UE based on a WUS.

According to an embodiment of the disclosure, the UE may independently perform the operation of turning on or off the main radio and the operation of reporting the capability of the UE inducing the WUR or the procedure of receiving information indicating whether the WUR is supported by the BS. For example, even when the operation of reporting the capability of the UE and the allowance procedure for the use of the WUR are not performed, the BS may transmit, to the UE, a signal indicating whether the WUR is to be used or indicating configuration information for reception of a WUS. Accordingly, the UE including the WUR from among UEs receiving a signal from the BS may perform ON/OFF of the main radio via the WUR.

According to an embodiment of the disclosure, after the operation of reporting the capability of the UE and the BS allowance procedure for the use of the WUR are performed, an operation of performing ON/OFF of the main radio via the WUR may be applied fully or partially to all UEs within a cell supported by the BS (e.g., an RRC_CONNECTED UE, an RRC_IDLE/RRC_INACTIVE UE, or a UE accessing the cell (e.g., RRC_CONNECTED UE)). When the operation of reporting the capability of the UE and the BS allowance procedure are not performed, the operation of performing ON/OFF of the main radio via the WUR may be applied to an RRC_IDLE/RRC_INACTIVE UE that camps on the cell supported by the BS.

Also, various embodiments of the disclosure may include all or some of various operations to be disclosed below, or at least one of combinations of the operations by the UE including the WUR and the BS.

Hereinafter, according to embodiments of the disclosure, an operation in which the UE including the WUR turns on or off the main radio will now be described. Various embodiments of the disclosure may include all or some of various operations to be disclosed below, or at least one of combinations of the operations by the UE including the WUR and the BS.

According to an embodiment of the disclosure, when the main radio of the UE is ON, the UE may receive a DL signal (or data) from the BS via the main radio. According to various embodiments of the disclosure, “main radio is ON” may be expressed, but is not limited to, as “the main radio is turned on” or “the main radio is activated,” and ON or OFF of the main radio (or transceiver) is not limited thereto and may be expressed as similar or substantially the same meaning. According to an embodiment of the disclosure, “main radio is activated” may mean that all or at least some of specific components (e.g., radio frequency (RF) or baseband (BB)) of the main radio are turned on or activated, or may be defined in the rules (e.g., the 3GPP technical specification (TS) document). However, according to various embodiments of the disclosure, it is not limited to what is described above, and the activation of the main radio may include similar or subsequently equal parameters or an operation being performed due to the parameters.

Alternatively, it may include that the main radio performs an operation of receiving a specific channel or a signal (e.g., SS/PBCH block including a synchronization signal or PDCCH including a DL control channel) which is defined in the 3GPP TS document.

According to an embodiment of the disclosure, when the main radio of the UE is OFF, the UE may be in a sleep period or may not receive a DL signal (or data) from the BS. According to various embodiments of the disclosure, “main radio is OFF” may be expressed, but is not limited to, as “the main radio is turned off” or “the main radio is deactivated,” or may be expressed as similar or subsequently equal meaning.

According to an embodiment of the disclosure, “main radio is deactivated” may mean that all or at least some of specific components (e.g., RF or BB) of the main radio are turned off or deactivated, or may be defined in the rules (e.g., the 3GPP TS document). However, according to various embodiments of the disclosure, it is not limited to what is described above, and the deactivation of the main radio may include similar or subsequently equal parameters or an operation being performed due to the parameters. Alternatively, the deactivation of the main radio may include that the main radio no longer performs an operation of receiving a specific channel or a signal (e.g., SS/PBCH block including a synchronization signal or PDCCH including a DL control channel) which is defined in the 3GPP TS document.

As described above, for power saving, only when the UE receives a WUS (or a WUS indicating an ON state) from the BS, the UE may trigger the main radio to ON via the WUR and may receive a DL signal from the BS via the main radio, and may turn off the main radio when not receiving a WUS (or receiving a WUS indicating an OFF state). In an optional embodiment of the disclosure, an on/off operation of the main radio based on reception of a WUS may also be applied to a random access procedure and UL transmission of the UE.

In this case, the UE in an RRC IDLE state or an RRC INACTIVE state may receive a WUS, and may receive PEI or attempt to receive paging in a PO/PF according to implementation of the UE. In this case, a method for determining a time/frequency resource for receiving the WUS and determining the PO and PF for receiving the paging in association with the resource through which the WUS is received is performed, and the method will be described in the disclosure. In the disclosure, an operation of determining the resource for receiving the WUS and determining the PO and PF in association with the resource through which the WUS is received may be performed in the same manner by the BS that transmits the WUS and the paging and the UE that receives the WUS and the paging. Also, in the disclosure, transmission and reception of paging may be understood as transmission and reception of a paging message.

When describing the following embodiments, operations or procedures described as being performed by the main radio or the WUR of the UE including the WUR (i.e., the UE having wake-up reception capability) may be interpreted as being performed by the UE including the WUR (i.e., the UE having wake-up reception capability).

For example, when the WUR receives a signal/channel, it may mean that the UE (and/or a processor included in the UE) receives the signal/channel through the WUR (or using the WUR). And/or, when the WUR performs measurement, it may mean that a signal/channel for measurement is received through the WUR and the UE (and/or processor included in the UE) performs a measurement operation based on the signal/channel.

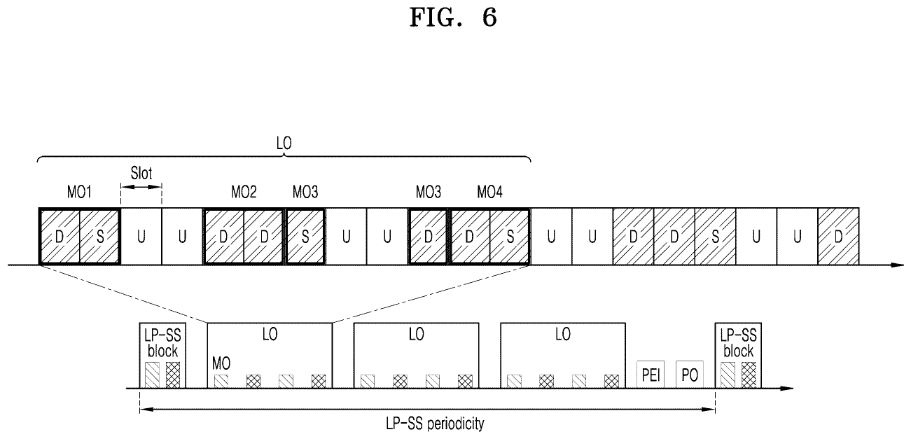

In embodiments of FIGS. 6 to 8, for convenience of explanation, when a UE receives a WUS, it may mean that the UE receives a WUS indicating an on state of a main radio.

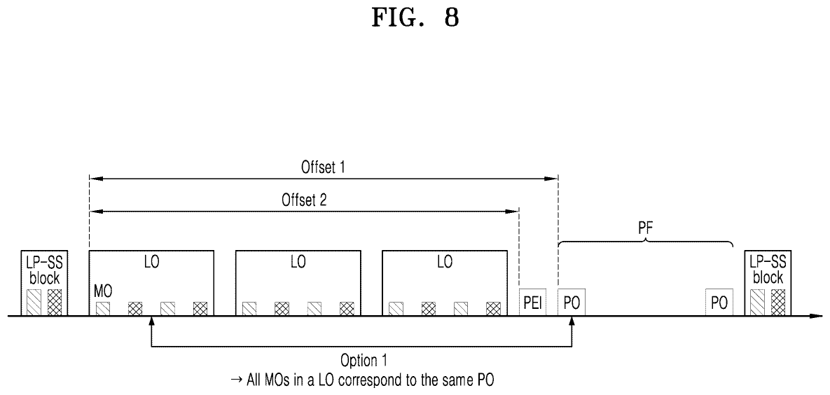

In the embodiments of FIGS. 6 and 8, a BS may transmit paging in a PF and PO determined based on transmission of a WUS, and the UE may receive the paging in a PF and PO determined based on reception of the WUS. In an embodiment of the disclosure, the BS may transmit paging in a plurality of PFs determined based on transmission of a WUS, and the UE may receive the paging from a plurality of PFs determined based on reception of the WUS. The number of the plurality of PFs may be limited to a pre-determined number by considering power consumption of the UE.

In the following embodiments of the disclosure, information provided through higher layer signaling information may be provided through at least one combination of the higher layer signal information or L1 signaling information.

FIG. 6 illustrates an example of configuring a resource for transmitting and receiving a WUS according to an embodiment of the disclosure.

Although a system in which a WUS is transmitted and received may be FFD or TDD, an example in a TDD system will be described in FIG. 6. The UE may determine whether a slot or a symbol is a DL slot/symbol, a UL slot/symbol, or a flexible slot/symbol based on DCI format 2_0 and configuration of TDD UL-DL resource configuration information indicating a DL slot (or symbol) resource and a UL slot (or symbol) resource of TDD.

An occasion for WUS monitoring of the UE is called a WUS occasion (LP-WUS occasion) and is referred to as an LO in the disclosure. Each LO may include one or more WUS monitoring occasions (LP-WUS monitoring Occasions) (MOs), and the UE may monitor and receive a WUS in each MO. Each LO may include N*K MOs, where N is the number of beams corresponding to one WUS and K is the number of MOs in each beam. FIG. 6 illustrates an example where N=2 and K=2.

The UE may receive a synchronization signal such as LP-SS or SSB corresponding to each beam before monitoring an LO to determine a beam corresponding to an MO, and may determine a beam direction optimized for the UE through the reception of the synchronization signal.

Next, a method of configuring MOs in an LO will be described. First, an MO is composed of two consecutive slots from a starting point, and only MOs that do not overlap UL slots/symbols among DL, UL, and flexible slot/symbols of TDD configuration determined by a higher layer signal or DCI may be selected. In this case, indices of the selected MOs may not be continuous. Next, as shown in FIG. 6, the MOs may be composed only of DL or flexible slot/symbols among the DL, UL, and flexible slots/symbols of the TDD configuration determined by the higher layer signal or DCI. Because the MOs include only the DL or flexible slot/symbols from the starting point, indices of the configured MOs may be continuous. FIG. 6 illustrates an example where four consecutive MOs are combined to constitute one LO. The starting point may be a first symbol of a 0^{th} radio frame or a specific symbol of a specific radio frame. The starting point may be defined in the standard or may be configured by the BS by using a higher layer signal.

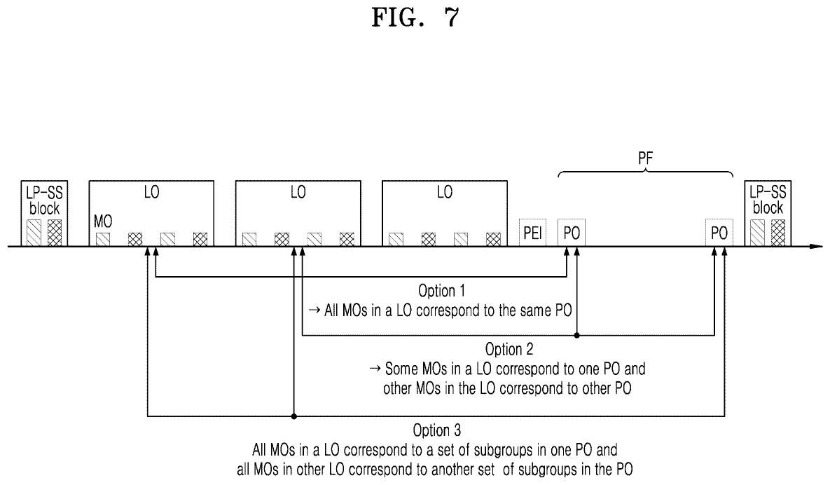

FIG. 7 illustrates an example of a method of defining an association between an LO/MO monitored by a UE and a PF/PO for receiving paging according to an embodiment of the disclosure.

Through the method of FIG. 7, a UE may determine a PF/PO, and may determine an LO or MO for monitoring a WUS in association with the determined PF/PO. Alternatively, the UE may determine an LO or MO for monitoring a WUS, and may determine a PF/PO for receiving paging in association with the determined LO/MO.

In Option 1, one LO monitored by a UE is associated with one PO in a PF. That is, when the UE receives a WUS in an MO in the LO, a paging message may be received in the PO in the PF due to the WUS. Alternatively, one LO including MOs where a WUS to be received by the UE is transmitted may be determined by the PO in the PF where a paging message to be received by the UE is transmitted. In this case, because LOs whose number corresponds to the number of POs are in one PF, the number of LOs in a paging cycle may be (the number of PFs in the paging cycle)*(the number of POs in one PF).

In Option 2, one LO monitored by the UE is associated with a plurality of POs in a PF. Accordingly, according to which MO among MOs included in one LO in which the UE receives a WUS, it may be associated with a specific PO. That is, when the UE receives a WUS in a first MO in the LO, a paging message may be received in a first PO in the PO due to the WUS. Alternatively, MOs in one LO where a WUS to be received by the UE is transmitted may vary according to the PO in the PF where a paging message to be received by the UE is transmitted. In this case, because an LO corresponding to one PF is necessary, the number of LOs in a paging cycle may be number of PFs in the paging cycle.

In Option 3, a plurality of LOs monitored by the UE are associated with one PO in a PF. Accordingly, when a WUS is received in MOs included in one of the plurality of LOs, it may be associated with one of a plurality of subgroups for receiving a specific PO. The number of the subgroups may be determined by the number of the plurality of LOs, and the subgroups may be determined according to which LO's MOs may be received among the plurality of LOs. That is, when the UE is a UE of a subgroup that receives a WUS in an MO included in a first LO among the plurality of LOs, a paging message may be received in one PO in the PF due to the WUS. Alternatively, a plurality of LOs where a WUS to be received by the UE is transmitted may be determined by the PO in the PF where a paging message to be received by the UE is transmitted, and which LO's MO may receive the WUS may be determined by which subgroup the UE belongs to. In this case, because a plurality of LOs whose number corresponds to the number of POs in one PF are necessary, the number of LOs in a paging cycle may be (the number of PFs in the paging cycle)*(the number of POs in one PF)*(the number of subgroups determined by the plurality of LOs).

As described in each option, the UE including a WUR may first determine a PF and a PO which may receive a paging message, may determine an LO and an MO accordingly, and may receive a related WUS, or may first receive a WUS through an LO and an MO, may determine a related PF and PO, and may receive a paging message. Specific embodiments according to the method will be described with reference to FIGS. 8, 9, 10, 11, 12, and 13. Also, a specific embodiment of each option of the method for determining an association between an LO/MO monitored by a UE and a PF/PO for receiving paging described with reference to 7 will be provided through FIGS. 8, 9, 10, 11, 12, and 13.

FIG. 8 illustrates an example of Option 1 of a method of defining an association between an LO/MO monitored by a UE and a PF/PO for receiving paging according to an embodiment of the disclosure.

FIG. 8 illustrates an embodiment where, in Option 1, a PF and a PO capable of receiving a paging message are first determined and then an LO and an MO are determined to receive a related WUS.

As described through Equations 2 and 3, a PF and a PO may be determined through parameters set in system information and UE_ID. Also, a resource for receiving PEI may be determined through other parameters set in the system information. In this case, a UE including a WUR may determine an LO and an MO capable of monitoring and receiving a WUS based on a time resource of the PF or the PO or a time resource of the PEI and an offset set through a higher layer signal from a BS. The offset may be set by the BS based on a time until a main radio of the UE switches to an ON state and a UE capability report on whether PEI is supported. For example, the offset may include a frame offset and a subframe offset. An LO may be located behind by the subframe offset based on a radio frame of a reference point located prior to a PF including an associated PO by the frame offset, and the UE may monitor a WUS in the LO determined in this manner. In another example, when the UE supports PEI, an offset for a case where PEI is received and paging is received and an offset for a case where only paging is received may be separately set. In another example, regardless of whether PEI is supported, one offset may be set and may be applied to both a case where PEI is received and paging is received and a case where only paging is received.

In another example, the offset may be added to or substitute PF_offset in Equation 2 to determine an SFN for an LO and an MO from an SFN of Equation 2. In this case, a WUS may be monitored in the LO or the MO that is located behind by the subframe offset based on the determined SFN.

When the UE monitors and receives a WUS based on the determined LO and MO, the PEI may be additionally received or paging may be received in the PF/PO based on the offsets.

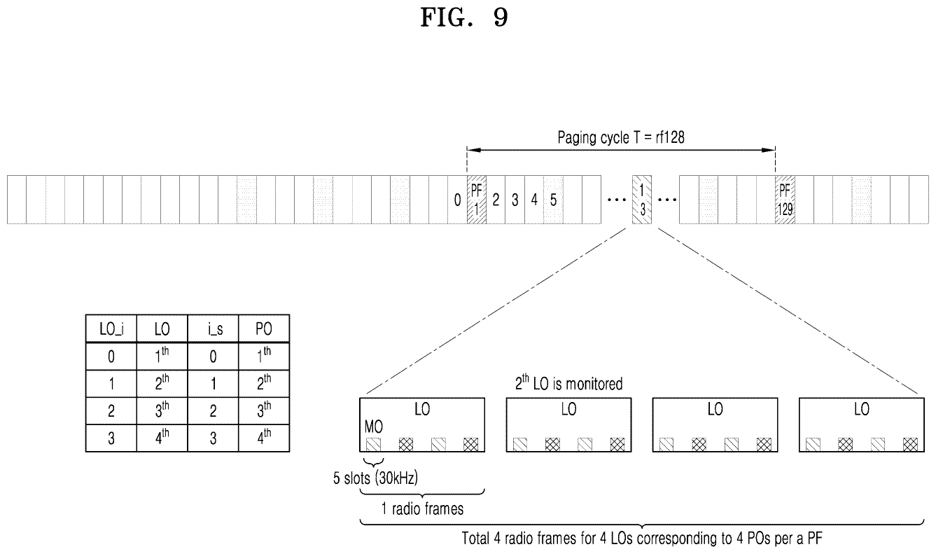

FIG. 9 illustrates an example of Option 1 of a method of defining an association between an LO/MO monitored by a UE and a PF/PO for receiving paging according to an embodiment of the disclosure.

FIG. 9 illustrates an embodiment where, in Option 1, a WUS is first received through an LO and an MO and then a related PF and PO are determined to receive a paging message.

First, in FIG. 9, a method of determining an LO and an MO will be described. A UE may monitor one or more LOs and MOs during a DRX cycle. A starting point of the LO and the MO for monitoring may be determined based on the following equation.

$$( SFN + LO\_offset ) mod T = ( TdivN\_LO ) * ( UE\_ID mod N\_LO ) . \qquad [ Equation 5 ]$$

An SFN for a starting point of an LO is determined based on Equation 5, LO_offset is a frame offset for determining a start LO for monitoring, T is a DRX cycle, N_LO is the number of (cell-common, that is, cell-specific) radio frames including the start LO per DRX cycle and is determined by higher layer signaling information, and UE_ID is a UE ID and is determined by a core network. In another example, T may be (DRX cycle-transition offset), instead of the DRX cycle. The transition offset may be a time until a main radio switches to an ON state, and may be determined to be one value set by the BS among a plurality of values.

When the UE determines an SFN for a starting point of an LO by using the equation, a position of the LO LO_i where a WUS may be monitored may be determined by i_s indicating a PO index.

In one example in FIG. 9, when it is assumed that LO_offset=119, T=128, N_LO=32, and UE_ID is expressed as UE_ID mod 32=1 and floor (UE_ID/32) mod 4=1, an SFN for a starting point of an LO in Equation 5 may be determined as follows.

$$( SFN + 119 ) mod 128 = ( 128 div 32 ) * ( UE\_ID mod 32 ) = 4 * 1 = 4 ,$$

Accordingly, a frame for the starting point of the LO that may be received by the UE including the UE_ID is 13.

In FIG. 9, the following example is illustrated to determine an LO where the UE may monitor a WUS:
Ns for configuring a PO is set to 4, and thus i_s=1;
One LO is set to include four MOs so that the number of beams corresponding to one WUS is N=2, and the number of MOs in each beam is K=2; and
Each MO is set to include five slots and one LO includes one radio frame.

In the above example, because LO_i=i_s=1, an LO where the UE may monitor a WUS may be determined to be a second LO included in Frame 14.

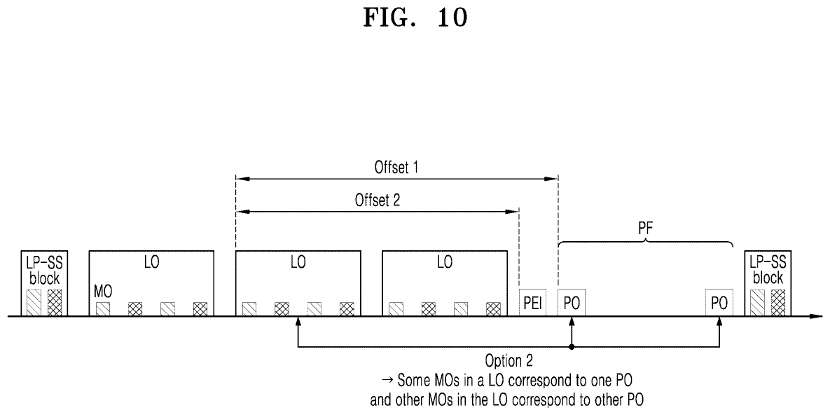

FIG. 10 illustrates an example of Option 2 of a method of defining an association between an LO/MO monitored by a UE and a PF/PO for receiving paging, according to an embodiment of the disclosure.

FIG. 10 illustrates an embodiment where, in Option 2, a PF and a PO capable of receiving a paging message are first determined and then an LO and an MO are determined accordingly to receive a related WUS. Unlike in Option 1, in Option 2, one LO monitored by a UE may be associated with a plurality of POs in one PF.

However, when an offset is applied based on the PF, the same method as in FIG. 8 may be applied. In detail, as described through Equations 2 and 3, a PF and a PO may be determined through parameters set in system information and UE_ID. Also, a resource for receiving PEI may be determined through other parameters set in the system information. In this case, a UE including a WUR may determine an LO and an MO capable of monitoring and receiving a WUS based on a time resource of the PF or the PO or a time resource of the PEI and an offset set through a higher layer signal from a BS. The offset may be set by the BS based on a time until a main radio of the UE switches to an ON state and a UE capability report on whether PEI is supported.

For example, the offset may include a frame offset and a subframe offset. An LO may be located behind by the subframe offset based on a radio frame of a reference point located prior to a PF including an associated PO by the frame offset, and the UE may monitor a WUS in the LO determined in this manner. In another example, when the UE supports PEI, an offset for a case where PEI is received and paging is received and an offset for a case where only paging is received may be separately set.

For example, regardless of whether PEI is supported, one offset may be set and may be applied to both a case where PEI is received and paging is received and a case where only paging is received. In another example, the offset may be added to or substitute PF_offset in Equation 2 to determine an SFN for an LO and an MO from an SFN of Equation 2. In this case, a WUS may be monitored in the LO or the MO that is behind by the subframe offset based on the determined SFN.

When the UE monitors and receives a WUS based on the determined LO and MO, the PEI may be additionally received or paging may be received in the PF/PO based on the offsets.

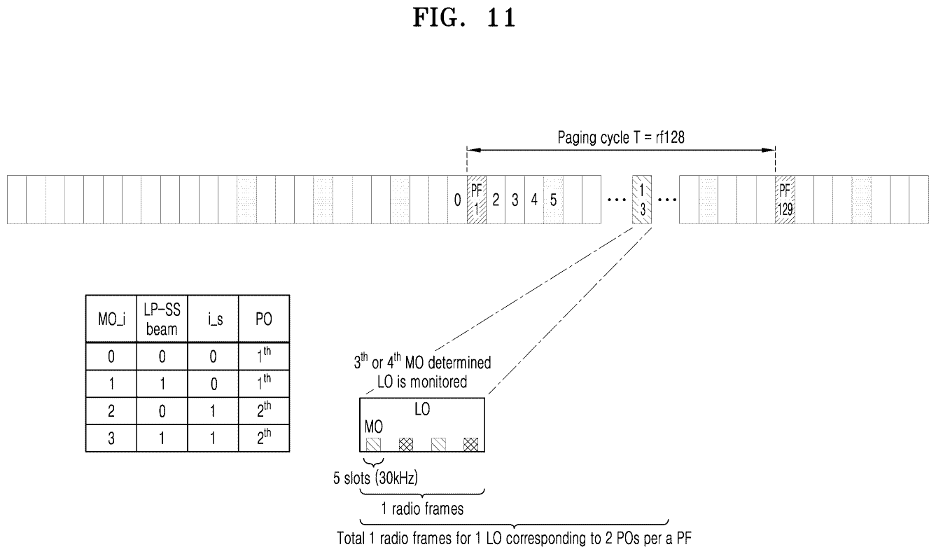

FIG. 11 illustrates an example of Option 2 of a method of defining an association between an LO/MO monitored by a UE and a PF/PO for receiving paging according to an embodiment of the disclosure.

FIG. 11 illustrates an embodiment where, in Option 2, a WUS is first received through an LO and an MO and then a related PF and PO are determined to receive a paging message.

First, in FIG. 11, a method of determining an LO and an MO will be described. A UE may monitor one or more LOs and MOs during a DRX cycle. A starting point of the LO and the MO for monitoring may be determined based on Equation 6.

$$( SFN + LO\_offset ) mod T = ( TdivN\_LO ) * ( UE\_ID mod N\_LO ) . \qquad [ Equation 6 ]$$

An SFN for a starting point of an LO is determined based on Equation 6, LO_offset is a frame offset for determining a start LO for monitoring, T is a DRX cycle, N_LO is the number of (cell-common, that is, cell-specific) radio frames including the start LO per DRX cycle and is determined by higher layer signaling information, and UE_ID is a UE ID and is determined by a core network. In another example, T may be (DRX cycle-transition offset), instead of the DRX cycle. The transition offset may be a time until a main radio switches to an ON state, and may be determined to be one value set by the BS among a plurality of values.

The UE may determine an SFN for a starting point of an LO by using the equation to determine a position of the LO where a WUS may be monitored, and may determine a position of the MO where a WUS may be monitored and received based on i_s and MO configuration in the LO.

In one example in FIG. 11, when it is assumed that LO_offset=119, T=128, N_LO=32, and UE_ID is expressed as UE_ID mod 32=1 and floor (UE_ID/32) mod 4=1, an SFN for a starting point of the LO in Equation 6 may be determined as follows.

$$( SFN + 119 ) mod 128 = ( 128 div 32 ) * ( UE\_ID mod 32 ) = 4 * 1 = 4 ,$$

Accordingly, a frame for the starting point of the LO that may be received by the UE including the UE_ID, that is, a frame for the LO where monitoring is performed for WUS reception, is 13.

In FIG. 11, the following example is illustrated to determine an MO in the LO where the UE may monitor a WUS:
Ns for configuring a PO is set to 2, and thus i_s=1;
One LO is set to include four MOs so that the number of beams corresponding to one WUS is N=2, and the number of MOs in each beam is K=2. Two consecutive MOs corresponds to each i_s value; and/or
Each MO is set to include five slots and one LO includes one radio frame.

In the above example, because i_s=1, an MO where the UE may monitor a WUS may be determined to be third and fourth MOs of the LO included in Frame 13. In this case, which MO is to be selected from among the third and fourth MOs may be mapped to a beam of LP-SS received by the WUR of the UE. That is, when the UE determines that a beam reception level or quality of the LP-SS transmitted via a specific beam is high, the UE may select an MO QCLed with the beam.

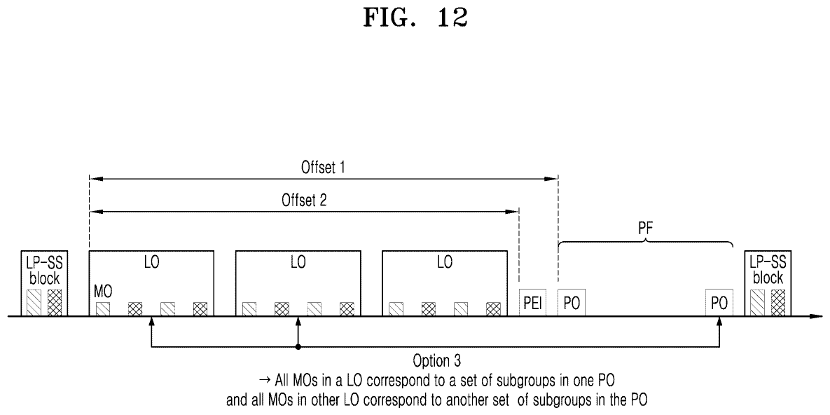

FIG. 12 illustrates an example of Option 3 of a method of defining an association between an LO/MO monitored by a UE and a PF/PO for receiving paging according to an embodiment of the disclosure.

FIG. 12 illustrates an example wherein, in Option 3, a PF and a PO capable of receiving a paging message are first determined and then an LO and an MO are determined accordingly to receive a related WUS. Unlike in Option 1, in Option 3, a plurality of LOs monitored by a UE may be associated with one PO in a PF. However, when an offset is applied based on the PF, the same method as in FIG. 8 may be applied. In detail, as described through Equations 2 and 3, a PF and a PO may be determined through parameters set in system information and UE_ID. Also, a resource for receiving PEI may be determined through other parameters set in the system information. In this case, a UE including a WUR may determine an LO and an MO capable of monitoring and receiving a WUS based on a time resource of the PF or the PO or a time resource of the PEI, and an offset set through a higher layer signal from a BS. The offset may be set by the BS based on a time until a main radio of the UE switches to an ON state and a UE capability report on whether PEI is supported.

For example, the offset may include a frame offset and a subframe offset. An LO may be located behind by the subframe offset based on a radio frame of a reference point located prior to a PF including an associated PO by the frame offset, and the UE may monitor a WUS in the LO determined in this manner.

In an example, when the UE supports PEI, an offset for a case where PEI is received and paging is received and an offset for a case where only paging is received may be separately set. In another example, regardless of whether PEI is supported, one offset may be set and may be applied to both a case where PEI is received and paging is received and a case where only paging is received. In another example, the offset may be added to or substitute PF_offset in Equation 2 to determine an SFN for an LO and an MO from an SFN of Equation 2. In this case, a WUS may be monitored in the LO or the MO that is behind by the subframe offset based on the determined SFN.

When the UE monitors and receives a WUS based on the determined LO and MO, the PEI may be additionally received or paging may be received in the PF/PO based on the offsets.

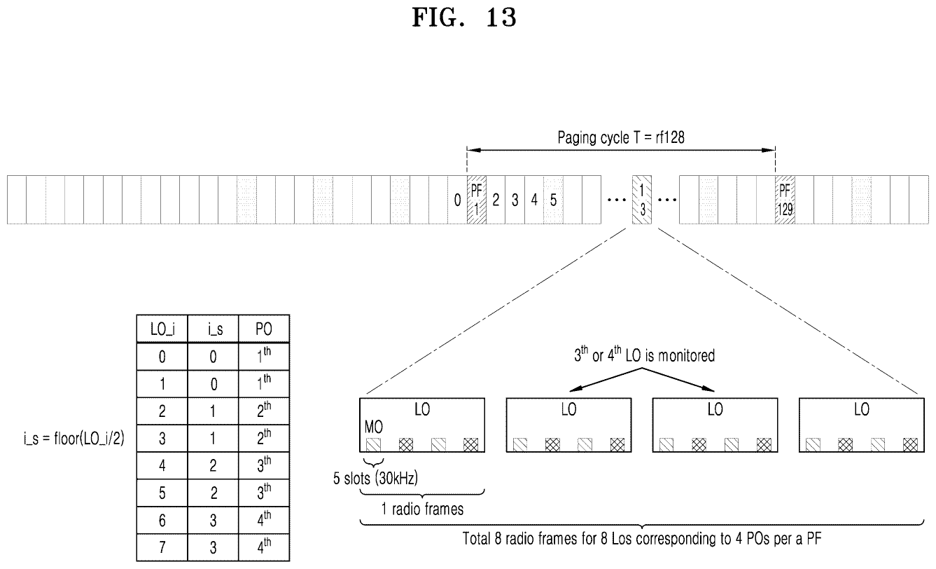

FIG. 13 illustrates an example of Option 3 of a method of defining an association between an LO/MO monitored by a UE and a PF/PO for receiving paging according to an embodiment of the disclosure.

FIG. 13 illustrates an embodiment where, in Option 3, a WUS is first received through an LO and an MO and then a related PF and PO are determined to receive a paging message.

First, in FIG. 13, a method of determining an LO and an MO will be described. A UE may monitor one or more LOs and MOs during a DRX cycle. A starting point of the LO and the MO for monitoring may be determined based on the following equation.

[Equation 7]

$$( SFN + LO\_offset ) mod T = ( TdivN\_LO ) * ( UE\_ID mod N\_LO ) .$$

An SFN for a starting point of an LO is determined based on Equation 7, LO_offset is a frame offset for determining a start LO for monitoring, T is a DRX cycle, N_LO is the number of (cell-common, that is, cell-specific) radio frames including the start LO per DRX cycle and is determined by higher layer signaling information, and UE_ID is a UE ID and is determined by a core network. In another example, T may be (DRX cycle-transition offset), instead of the DRX cycle. The transition offset may be a time until a main radio switches to an ON state, and may be determined to be one value set by the BS among a plurality of values.

When the UE determines an SFN for a starting point of an LO by using the equation, a position of the LO LO_i where a WUS may be monitored may be determined by i_s indicating a PO index.

In one example in FIG. 13, when it is assumed that LO_offset=119, T=128, N_LO=32, and UE_ID is expressed as UE_ID mod 32=1 and floor (UE_ID/32) mod 4=1, an SFN for a starting point of the LO in Equation 5 may be determined as follows.

$$( SFN + 119 ) mod 128 = ( 128 div 32 ) * ( UE\_ID mod 32 ) = 4 * 1 = 4.$$

Accordingly, a frame for the starting point of the LO that may be received by the UE including the UE_ID is 13.

In FIG. 13, the following example is illustrated to determine an LO where the UE may monitor a WUS:
Ns for configuring a PO is set to 4, and thus i_s=1;
A total of 8 LOs are set to be mapped to i_s so that one PO is divided into two UE subgroups and mapped to two LOs. i_s=floor (LO_i/2);
One LO is set to include four MOs so that the number of beams corresponding to one WUS is N=2, and the number of MOs in each beam is K=2; and/or
Each MO is set to include five slots and one LO includes one radio frame.

In the above example, because i_s=1, an LO where the UE may monitor a WUS may be determined to be a third LO included in Frame 15 and a fourth LO included in Frame 16. Whether the UE is to monitor the third LO or the fourth LO may be determined according to a subgroup for receiving a WUS to which the UE belongs.

Hereinafter, according to various embodiments of the disclosure, a procedure for waking up a main radio when the main radio is in a sleep state will be described. According to an embodiment of the disclosure, an operation of waking up a main radio may be performed in combination with at least one of various operations according to various embodiments of the disclosure of FIGS. 1 to 8 or may be performed separately, and may not be an essential element.

According to an embodiment of the disclosure, when there is a channel or a signal to be transmitted to a UE, a BS may transmit a WUS to the UE. The UE or a WUR may receive the WUS and may turn on a main radio. According to an embodiment of the disclosure, an operation of receiving a WUS itself may be an instruction to wake up the main radio. According to an embodiment of the disclosure, the WUS may include K information bits, and information indicating to wake up the main radio may be mapped to the K information bits. For example, when the information bits included in the WUS are 1-bit information, “1” may indicate ON and “0” may indicate OFF. Alternatively, “0” may indicate ON and “1” may indicate OFF.

According to an embodiment of the disclosure, from a BS transmission perspective, when to transmit a WUS before transmission of a channel or a signal may be predefined. From a UE reception perspective, when it is available to receive a WUS before reception of a channel or a signal may also be predefined.

According to an embodiment of the disclosure, the UE may transmit, to the BS, information about a time offset between transmission of a WUS and transmission of a channel/signal, and the BS may configure the UE with the time offset between transmission of the WUS and transmission of the channel/signal to the UE based on the received information. According to an embodiment of the disclosure, the UE may transmit the information about the time offset between transmission of the WUS and transmission of the channel/signal to the BS, through a UE capability information report procedure or through a random access preamble or a UL data channel in a random access procedure. However, the disclosure is not limited thereto, and the UE may transmit the information about the time offset to the BS through higher layer signaling information and/or through various signals and/or a combination of the various signals.

The BS may configure the UE with the information about the time offset between transmission of the WUS and transmission of the channel/signal through a DL data channel of a random access response (e.g., Message 2) or a random access contention resolution (e.g., Message 4) in the random access procedure. However, the disclosure is not limited thereto, and the BS may configure the UE with the information about the time offset through higher layer signaling information and/or through various signals and/or a combination of the various signals.

According to an embodiment of the disclosure, when there is a periodic channel or a periodic signal to be transmitted by the BS to the UE, the BS does not transmit a WUS whenever the BS has a channel or a signal to be transmitted, but instead, the UE or the WUR may turn on a main radio, according to a period based on configuration information of the periodic channel or the periodic signal which is configured by the BS.

According to an embodiment of the disclosure, the BS may transmit a WUS only at first transmission of the periodic channel or the periodic signal, and may omit transmission of the WUS at subsequent repeated transmissions of the channel or signal. In this case, the UE or the WUR may turn on the main radio based on the period according to the configuration information of the periodic channel or the periodic signal configured by the BS.

According to an embodiment of the disclosure, a type of the periodic channel or the periodic signal transmitted and received by the BS and the UE may be predefined. According to an embodiment of the disclosure, a type of the periodic channel or the periodic signal may be configured by the BS. For example, the BS may configure the UE with a type of the periodic channel or the periodic signal through the DL data channel of the random access response (e.g., Message 2) or the random access contention resolution (e.g., Message 4), or may configure the UE through higher layer signaling information and/or L1 signaling information indicating configuration information for WUS reception.

According to an embodiment of the disclosure, when there is a channel or a signal (e.g., a physical random access channel (PRACH), a scheduling request (SR), or a buffer status report (BSR)) to be transmitted by the UE to the BS or when the UE performs L1/L3-based measurement, the UE or the WUR may turn on the main radio regardless of a WUS transmitted by the BS.

According to an embodiment of the disclosure, with respect to UL transmission or L1/L3-based measurement from the UE to the BS, an operation in which the WUR receives a WUS and turns on or off the main radio of the UE may not be applied. That is, in this case, even when a WUS is not received, based on configuration of a higher layer signal from the BS (e.g., whether to turn on/off the main radio based on resource and transmission/reception configuration related to UL or L1/L3-based measurement or WUS reception, or whether to turn on/off the main radio based on the configuration related to UL or L1/L3-based measurement regardless of the WUS reception), the WUR may turn on the main radio in advance or the UE (or the main radio) may be in an already ON state, and thus, the main radio may not be turned on by the WUS.

According to an embodiment of the disclosure, a type of a UL channel or a UL signal or L1/L3-based measurement of the UE transmitted from the UE regardless of a reception operation of a WUS may be predefined. According to an embodiment of the disclosure, a type of a UL channel or UL signal or L1/L3-based measurement may be configured by the BS. For example, the BS may configure the UE with the type of the UL channel or the UL signal or L1/L3-based measurement through the DL data channel of the random access response (e.g., Message 2) or the random access contention resolution (e.g., Message 4), or may configure the UE through higher layer signaling information and/or L1 signaling information indicating configuration information for WUS reception.

Hereinafter, according to an embodiment of the disclosure, an operation of turning off a main radio when the main radio is in an on state will be described. According to an embodiment of the disclosure, when a main radio is in an on state, an operation of waking up the main radio may be performed in combination with at least one of various operations according to various embodiments of the disclosure or may be separately performed, and may not be an essential element.

When there is no channel or signal to be transmitted to a UE, a BS according to an embodiment of the disclosure may transmit a sleep signal to the UE. The UE or a WUR may receive the sleep signal and may turn off a main radio. According to an embodiment of the disclosure, an operation of receiving the sleep signal itself may be an instruction to put the main radio to sleep (or turn off the main radio). According to an embodiment of the disclosure, the sleep signal may be configured as a separate sequence from a WUS. According to an embodiment of the disclosure, the sleep signal may include information to which information indicating to put the main radio to sleep is mapped from among K information bits included in the WUS. For example, when the sleep signal is 1-bit information, “0” may indicate OFF and “1” may indicate ON. For example, when the sleep information is 1-bit information, “1” may indicate OFF and “0” may indicate ON. That is, when information bits included in a specific signal indicate OFF, the specific signal may be interpreted as the sleep signal, and when information bits indicate ON, the specific signal may be interpreted as the WUS. That is, the sleep signal and the WUS may be distinguished according to an information bit value in the same signal.

According to an embodiment of the disclosure, the main radio of the UE may be turned off when a configured condition is satisfied. For example, the condition configured for the main radio may correspond to a case where the main radio fails to detect or decode a DL control channel, or a specific channel or signal during a configured period. According to an embodiment of the disclosure, the BS may configure the UE with a plurality of pieces of configuration information (e.g., information including a period and a specific channel or signal) used for the UE to determine OFF of the main radio through higher layer signaling information and/or L1 signaling information indicating configuration information for WUS reception.

According to an embodiment of the disclosure, the main radio of the UE may always be turned off after a channel or a signal is received. According to an embodiment of the disclosure, after the WUR receives a WUS from the BS and the main radio is turned on to receive a channel or a signal, the main radio may be turned off. According to an embodiment of the disclosure, a time for the main radio to be turned off after reception of the channel or the signal is completed may be predefined. According to an embodiment of the disclosure, the UE may transmit, to the BS, information about the time for the main radio to be turned off, and the BS may configure the UE with the time based on the received information. According to an embodiment of the disclosure, the information about the time transmitted by the UE may be transmitted to the BS through a UE capability information report procedure. According to an embodiment of the disclosure, the information about the time transmitted by the UE may be transmitted to the BS through a random access preamble or a UL data channel. However, the disclosure is not limited thereto, and the UE may transmit the information about the time to the BS through higher layer signaling information. The BS may configure the UE with the information about the time transmitted by the UE through a DL data channel of a random access response (e.g., Message 2) or a random access contention resolution (e.g., Message 4). However, the disclosure is not limited thereto, and the BS may configure the UE with the information about the time through higher layer signaling information.

According to an embodiment of the disclosure, when the UE or the main radio of the UE is in an RRC_CONNECTED state, the UE may be configured with connected mode DRX (C-DRX) and thus, the main radio may wake up and perform PDCCH reception at every DRX cycle. According to an embodiment of the disclosure, when the UE or the main radio of the UE is in the RRC_CONNECTED state, the UE (or the main radio) may be configured to receive a signal indicating whether the UE is to receive a PDCCH in a next DRX cycle.

According to an embodiment of the disclosure, when the main radio is in an RRC_IDLE/RRC_INACTIVE state, the UE may be configured with idle mode DRX (I-DRX), and thus, the main radio may wake up and receive a paging PDCCH at every paging cycle. According to an embodiment of the disclosure, when the UE or the main radio of the UE is in the RRC_CONNECTED state, the UE (or the main radio) may be configured to receive a signal indicating whether the UE is to receive a paging PDCCH in a next paging cycle.

Hereinafter, according to an embodiment of the disclosure, provided is a procedure by a UE operating as a WUR, when an ON/OFF indication operation based on WUS reception by the WUR and a main radio and an operation based on configuration of C-DRX or I-DRX coexist. According to an embodiment of the disclosure, an operation of the UE or the main radio of the UE related to an RRC CONNECTED/IDLE/INACTIVE state may be performed in combination with at least one of various operations according to embodiments of the disclosure of FIGS. 1 to 8 or may be performed separately, and may not be an essential element.

According to an embodiment of the disclosure, when the UE including the WUR performs an operation of receiving a WUS and turning on or off the main radio of the UE, the UE may not perform configuration of C-DRX or I-DRX and an operation according to the configuration. In this case, instead of performing the configuration of C-DRX or I-DRX and the operation according to the configuration, the UE may turn on the main radio of the UE only when a WUS indicating to wake up the main radio is received, and may receive a physical downlink control channel (PDCCH) and a physical downlink shared channel (PDSCH) which are defined or configured to be received in C-DRX or I-DRX.

According to an embodiment of the disclosure, when the UE or the main radio of the UE is in the RRC_CONNECTED state and an operation performed by the WUR is configured or activated by the BS, the UE may turn on the main radio when the WUR receives a WUS indicating to wake up the main radio, and may perform a C-DRX-related operation (e.g., the main radio receiving a PDCCH within drx_onDurationTimer at every DRX cycle) configured by the BS. According to an embodiment of the disclosure, the UE (or the main radio) may not perform an operation configured for the UE to receive a signal (e.g., DCI format 2_6, WUS) indicating whether to receive a PDCCH in a next DRX cycle.

According to an embodiment of the disclosure, when the UE or the main radio of the UE is in the RRC_IDLE/INACTIVE state and an operation performed by the WUR is configured or activated by the BS, the UE may turn on the main radio when the WUR receives a WUS indicating to wake up the main radio, and may perform an I-DRX-related operation (e.g., the main radio waking up and receiving a paging PDCCH at every paging cycle) configured by the BS. According to an embodiment of the disclosure, the UE (or the main radio) may not perform an operation configured for the UE to receive a signal (e.g., DCI format 2_7, paging early indication) indicating whether to receive a paging PDCCH in a next paging cycle.

According to an embodiment of the disclosure, instead of an operation according to the configuration related to C-DRX or I-DRX, the UE may perform an operation for waking up the main radio and an operation for turning off the main radio according to the WUR and a WUS according to an embodiment of the disclosure. When an operation performed by the WUR is deactivated by the BS, the operations related to C-DRX or I-DRX configured by the BS may be performed again. That is, a priority of an operation based on a WUS corresponding to the WUR may be higher than a priority of an operation according to DRX configuration.

According to an embodiment of the disclosure, when an operation performed by the WUR of the UE is configured or activated by the BS, and the UE or the WUR receives a WUS to turn on the main radio, the UE may transition to an RRC_CONNECTED state or may transition to an RRC_IDLE or RRC_INACTIVE state. According to an embodiment of the disclosure, to which state the UE may transition may be predetermined or may be determined by using higher layer signaling information and/or L1 signaling information regarding WUR operation configuration by the BS.

According to an embodiment of the disclosure, in an example of a case where information about transition of the UE is predetermined, a state of the main radio may follow a state in which the main radio was most recently turned on and nearly off immediately before a current on time. According to an embodiment of the disclosure, in another example of a case where information about transition of the UE is predetermined, a state of the main radio may not be affected by configuration of an operation of the WUR and whether to activate the operation. For example, the state of the main radio of the UE may be determined only by higher layer signaling information indicating at least one of RRC_CONNECTED, RRC_IDLE, or RRC_INACTIVE, and the UE may determine that the state of the main radio is not changed by the configuration of the operation of the WUR and whether to activate the operation.

According to an embodiment of the disclosure, a WUS may include K information bits, and information about at least one of whether the main radio transitions to an RRC_CONNECTED state, an RRC_IDLE state, or an RRC_INACTIVE state may be mapped to the K information bits.

According to an embodiment of the disclosure, when the UE or the main radio of the UE is RRC_CONNECTED based on the determined state of the UE, it may be configured by the BS that the main radio may wake up and receive a PDCCH at every DRX cycle due to C-DRX configured by the BS, or the UE (or the main radio) receives a signal indicating whether to receive a PDCCH in a next DRX cycle. According to an embodiment of the disclosure, when an operation of turning off the main radio according to various embodiments of the disclosure is performed while the UE receives a PDCCH (e.g., during a PDCCH reception period), the UE may priorly perform a procedure for turning off the main radio.

According to an embodiment of the disclosure, when the UE or the main radio of the UE is RRC_IDLE/INACTIVE, the main radio may wake up and receive a paging PDCCH at every paging cycle due to I-DRX configured by the BS. The UE (or the main radio) may be configured by the BS to receive a signal indicating whether to receive a paging PDCCH in a next paging cycle. When an operation for turning off the main radio according to various embodiments of the disclosure is performed while the UE receives a paging PDCCH (e.g., during a paging PDCCH reception period), the UE may priorly perform a procedure for turning off the main radio.

According to various embodiments of the disclosure, it is obvious that the various operations of the UE (or the main radio or the WUR) may be performed regardless of the order, and an entity performing the operations may be the UE, the main radio, or the WUR.

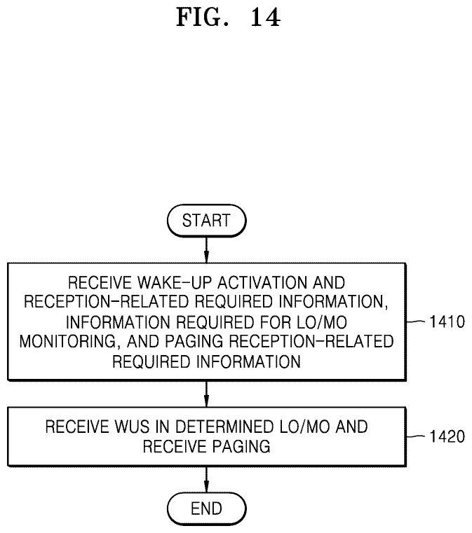

FIG. 14 illustrates a flowchart for an operating method of a UE, according to an embodiment of the disclosure.

Various modifications may be made to the operating method of FIG. 14. For example, although a series of operations are illustrated, various operations in each drawing may overlap, may be performed in parallel, may be performed in a different order, or may be performed several times. In another example, some operations may be omitted or may be replaced with other operations.

In operation 1410, a UE may receive a wake-up activation signal or a wake-up deactivation signal. The UE may receive the wake-up activation signal from a BS to receive a WUS by using a WUR, or may receive the wake-up deactivation signal from the BS to no longer receive a WUS by using the WUR. Also, the UE may receive information for WUS reception from the BS.

The UE according to an embodiment of the disclosure may receive information for LO and MO monitoring from the BS. The UE according to an embodiment of the disclosure may receive a signal indicating whether to use the WUR or configuration information for WUS reception from the BS. Also, the UE according to an embodiment of the disclosure may receive information for paging reception from the BS.

In operation 1420, the UE may receive a WUS in a determined LO and MO and may receive paging accordingly. In an embodiment of the disclosure, when the WUR is configured or activated to be turned on to search for a WUS and a WUS is received, paging may be received in a PF/PO determined according to an embodiment of the disclosure. In an embodiment of the disclosure, when the WUR is not configured or activated, paging may be received in a PF/PO determined based on a paging reception method for a legacy UE.

More detailed descriptions of an operation of the UE according to an embodiment of the disclosure may be found in the description of the embodiment of the disclosure described above.

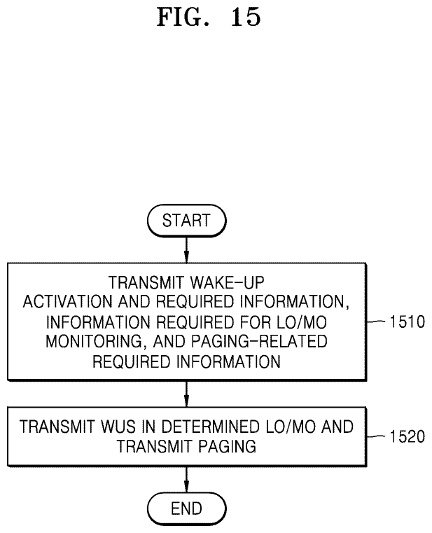

FIG. 15 illustrates a flowchart for an operating method of a BS, according to an embodiment of the disclosure. Various modifications may be made to the operating method of FIG. 15. For example, although a series of operations are illustrated, various operations in each drawing may overlap, may be performed in parallel, may be performed in a different order, or may be performed several times. In another example, some operations may be omitted or may be replaced with other operations.

In operation 1510, a BS may transmit a wake-up activation signal or a wake-up deactivation signal. The BS may transmit the wake-up activation signal to a UE to receive a WUS by using a WUR, or may transmit the wake-up deactivation signal to the UE to no longer receive a WUS by using the WUR. Also, the BS may transmit information for WUS reception to the UE. Information for LO and MO monitoring according to embodiments of the disclosure may be received from the BS. In an embodiment of the disclosure, the BS may transmit a signal indicating whether to use the WUR or configuration information for WUS reception to the UE. Also, the BS may transmit information for paging reception to the UE.

In operation 1520, the BS may transmit a WUS in a determined LO and MO according to an embodiment of the disclosure and may transmit paging. In an embodiment of the disclosure, when the WUR is configured or activated to be turned on to search for a WUS, and a WUS is transmitted so that the UE receives the WUS, the BS may transmit paging in a PF/PO determined according to an embodiment of the disclosure. In an embodiment of the disclosure, when the BS does not configure or activate the WUR, paging may be transmitted in a PF/PO determined based on a paging reception method for a legacy UE.

More detailed descriptions of an operation of the BS according to an embodiment of the disclosure may be found in the description of the embodiment of the disclosure described above.

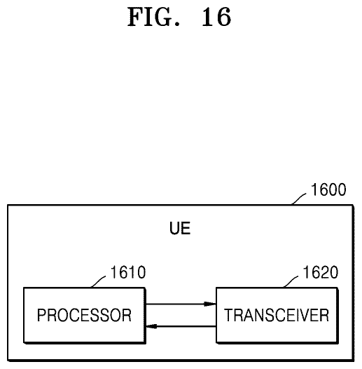

FIG. 16 illustrates a configuration of a UE according to an embodiment of the disclosure.

A UE 1600 may include a transceiver 1620 including a UE receiver and a UE transmitter, a memory (not shown), and a UE processor (or a UE controller or a processor 1610). The transceiver 1620, the memory, and the processor 1610 may operate according to a communication method of the UE described above. However, components of the UE are not limited thereto. For example, the UE may include more or fewer components than those illustrated in FIG. 16. In addition, the transceiver, the memory, and the processor may be implemented as a single chip.

The memory may store various data, programs, or applications for driving and controlling the UE according to an embodiment of the disclosure.

The memory may include a non-volatile memory including at least one of a flash memory type, a hard disk type, a multimedia card micro type, a card type memory (e.g., SD or XD memory), a read-only memory (ROM), an electrically erasable programmable read-only memory (EPPROM), or a programmable read-only memory (PROM), and a volatile memory such as a random-access memory (RAM) or a static random-access memory (SRAM).

The memory may store instructions, data structures, and program code readable by the processor 1610.

Also, the processor 1610 may control a series of processes so that the UE operates according to the above embodiment of the disclosure.

The processor 1610 may include a plurality of processors and may execute a program stored in the memory to perform an operation of controlling the components of the UE.

The processor 1610 may include a hardware component for performing arithmetic, logic, and input/output operations and signal processing. One or more processors included in the processor may be circuitry such as a system on chip (SoC), an integrated circuit (IC), etc. The processor 1610 may include at least one of, for example, but not limited to, a central processing unit (CPU), a microprocessor, a graphics processing unit (GPU), an application-specific integrated circuit (ASIC), a digital signal processor (DSP), a digital signal processing device (DSPD), a programmable logic device (PLD), or a field-programmable gate array (FPGA).

The processor 1610 may write data to the memory or read data stored in the memory, and particularly, may process data according to predefined operation rules by executing programs or at least one instruction stored in the memory.

The processor 1610 may execute at least one instruction stored in the memory so that the UE performs the above operations.

For example, the processor may control the components of the UE so that the UE receives DCI including two layers to receive a plurality of PDSCHs at the same time. The processor may include a plurality of processors and execute a program stored in the memory to perform an operation of controlling the components of the UE.

The transceiver 1620 may transmit and receive a signal to and from a BS. The signal may include control information and data. To this end, the transceiver may include an RF transmitter for up-converting and amplifying a frequency of a transmitted signal and an RF receiver for low-noise amplifying and down-converting a frequency of a received signal. However, the configuration of the transceiver is merely an example, and components of the transceiver are not limited to the RF transmitter and the RF receiver.

Also, the transceiver 1620 may receive a signal through a wireless channel and output the signal to the processor 1610, and may transmit a signal output from the processor 1610 through the wireless channel.

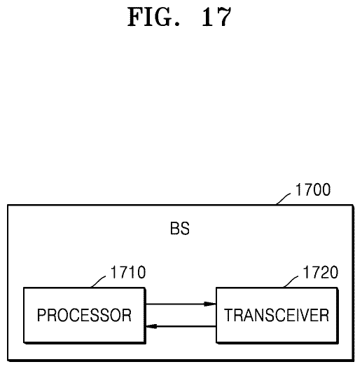

FIG. 17 illustrates a configuration of a BS according to an embodiment of the disclosure.

A BS 1700 may include a transceiver 1720 including a BS receiver and a BS transmitter, a memory (not shown), and a BS processor (or a BS controller or a processor 1710). The transceiver 1720, the memory, and the processor 1710 of the BS may operate according to a communication method of the BS described above. However, components of the BS are not limited thereto. For example, the BS may include more or fewer components than those illustrated in FIG. 17. In addition, the transceiver, the memory, and the processor may be implemented as a single chip.

The memory may store various data, programs, or applications for driving and controlling the BS according to an embodiment of the disclosure.

The memory may include a non-volatile memory including at least one of a flash memory type, a hard disk type, a multimedia card micro type, a card type memory (e.g., SD or XD memory), a read-only memory (ROM), an electrically erasable programmable read-only memory (EPPROM), or a programmable read-only memory (PROM), and a volatile memory such as a random-access memory (RAM) or a static random-access memory (SRAM).

The memory may store instructions, data structures, and program code readable by the processor 1710.

Also, the processor 1710 may control a series of processes to allow the BS to operate according to the above embodiment of the disclosure.

The processor 1710 may include a plurality of processors and execute a program stored in the memory to perform an operation of controlling the components of the BS.

The processor 1710 may include a hardware component for performing arithmetic, logic, and input/output operations and signal processing. One or more processors included in the processor may be circuitry such as a system on chip (SoC), an integrated circuit (IC), etc. The processor 1610 may include at least one of, for example, but not limited to, a central processing unit (CPU), a microprocessor, a graphics processing unit (GPU), an application-specific integrated circuit (ASIC), a digital signal processor (DSP), a digital signal processing device (DSPD), a programmable logic device (PLD), or a field-programmable gate array (FPGA).

The processor 1710 may write data to the memory or read data stored in the memory, and particularly, may process data according to predefined operation rules by executing programs or at least one instruction stored in the memory.

The processor 1710 may execute at least one instruction stored in the memory so that the BS performs the above operations.

The transceiver 1720 may transmit and receive a signal to and from a UE. The signal may include control information and data. To this end, the transceiver may include an RF transmitter for up-converting and amplifying a frequency of a transmitted signal and an RF receiver for low-noise amplifying and down-converting a frequency of a received signal. However, the configuration of the transceiver is merely an example, and components of the transceiver are not limited to the RF transmitter and the RF receiver.

Also, the transceiver 1720 may receive a signal through a wireless channel and output the signal to the processor 1710, and may transmit a signal output from the processor 1710 through the wireless channel.

The methods according to the claims or the embodiments described herein may be implemented by hardware, software, or a combination of hardware and software.

When the methods are implemented by software, a computer-readable storage medium storing one or more programs (software modules) may be provided. The one or more programs stored in the computer-readable storage medium are configured to be executed by one or more processors in an electronic device. The one or more programs include instructions for allowing an electronic device to execute the methods according to the claims or the embodiments of the disclosure.

The programs (e.g., software modules or software) may be stored in a random-access memory (RAM), a non-volatile memory including a flash memory, a read-only memory (ROM), an electrically erasable programmable read-only memory (EEPROM), a magnetic disc storage device, a compact disc-ROM (CD-ROM), a digital versatile disc (DVD), another optical storage device, or a magnetic cassette. Alternatively, the programs may be stored in a memory including any combination of some or all of the above storage media. Also, a plurality of constituent memories may be provided.

Also, the programs may be stored in an attachable storage device accessible through any or a combination of a communication network such as the Internet, an intranet, a local area network (LAN), a wide LAN (WLAN), a storage area network (SAN), or a combination thereof. Such a storage device may access, via an external port, an apparatus for performing an embodiment of the disclosure. Also, a separate storage device on a communication network may access an apparatus for performing an embodiment of the disclosure.

In the afore-described embodiments of the disclosure, elements included in the disclosure are expressed in a singular or plural form according to specific embodiments of the disclosure. However, singular or plural expressions have been selected properly for a condition provided for convenience of description, and the disclosure is not limited to singular or plural components. Components expressed as plural may be configured as a single component, or a component expressed as singular may be configured as plural components.

Meanwhile, specific embodiments have been described in the detailed description of the disclosure, but various modifications may be possible without departing from the scope of the disclosure. For example, some or all of embodiments may be combined with some or all of other embodiments of the disclosure, and it is obvious that such combinations also correspond to an embodiment provided in the disclosure. Thus, it will be apparent to one of ordinary skill in the art that the scope of the disclosure is not limited to the embodiments described herein and should be defined by the appended claims and their equivalents.

Meanwhile, specific embodiments have been described in the detailed description of the disclosure, but various modifications may be possible without departing from the scope of the disclosure. Therefore, the scope of the disclosure should not be limited to the embodiments described above, but should be determined not only by the scope of the following claims, but also by the equivalents of the claims.

An operating method of a UE according to an embodiment of the disclosure may include receiving information related to monitoring of a WUS from a BS.

The operating method of the UE according to an embodiment of the disclosure may include determining an occasion in which the WUS is transmitted, based on the information.

The operating method of the UE according to an embodiment of the disclosure may include receiving the WUS from the BS, based on the occasion.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE), the method comprising:
receiving time division duplex uplink-downlink (TDD UL-DL) configuration information via a higher layer signaling;
identifying at least one UL symbol configured for the UE based on the TDD UL-DL configuration information; and
based on the UE in a radio resource control (RRC)_IDLE state or an RRC_INACTIVE state, monitoring a wake up signal (WUS) on one or more symbols except the identified at least one UL symbol.

2. The method of claim 1, further comprising:
in case that a first offset for a low power WUS occasion (LO) is configured based on a higher layer parameter, identifying a reference frame, which starts a number of frames prior to a paging frame associated with the LO, for monitoring the WUS,
wherein the number of frames is indicated by the first offset.

3. The method of claim 2, further comprising:
identifying a first monitoring occasion for the WUS, based on a second offset relative to the reference frame.

4. The method of claim 3, wherein the second offset is configured by a higher layer parameter.

5. A method performed by a base station, the method comprising:
transmitting time division duplex uplink-downlink (TDD UL-DL) configuration information via a higher layer signaling, wherein at least one UL symbol configured for a user equipment (UE) is identified based on the TDD UL-DL configuration information; and
based on the UE in a radio resource control (RRC)_IDLE state or an RRC_INACTIVE state, transmitting a wake up signal (WUS) on one or more symbols except the identified at least one UL symbol.

6. The method of claim 5, wherein in case that a first offset for a low power WUS occasion (LO) is configured based on a higher layer parameter, a reference frame for monitoring the WUS starts a number of frames prior to a paging frame associated with the LO, and
wherein the number of frames is indicated by the first offset.

7. The method of claim 6, wherein a first monitoring occasion for the WUS is identified at the UE, based on a second offset relative to the reference frame.

8. The method of claim 7, wherein the second offset is configured by a higher layer parameter.

9. A user equipment (UE) comprising:
a transceiver; and
at least one processor coupled with the transceiver and configured to:
receive time division duplex uplink-downlink (TDD UL-DL) configuration information via a higher layer signaling,
identify at least one UL symbol configured for the UE based on the TDD UL-DL configuration information, and
based on the UE in a radio resource control (RRC)_IDLE state or an RRC_INACTIVE state, monitor a wake up signal (WUS) on one or more symbols except the identified at least one UL symbol.

10. The UE of claim 9, wherein the at least one processor is further configured to:
in case that a first offset for a low power WUS occasion (LO) is configured based on a higher layer parameter, identify a reference frame, which starts a number of frames prior to a paging frame associated with the LO, for monitoring the WUS, and
wherein the number of frames is indicated by the first offset.

11. The UE of claim 10, wherein the at least one processor is further configured to:
identify a first monitoring occasion for the WUS, based on a second offset relative to the reference frame.

12. The UE of claim 11, wherein the second offset is configured by a higher layer parameter.

13. A base station comprising:
a transceiver; and
at least one processor coupled with the transceiver and configured to:
transmit time division duplex uplink-downlink (TDD UL-DL) configuration information via a higher layer signaling, wherein at least one UL symbol configured for a user equipment (UE) is identified based on the TDD UL-DL configuration information, and
based on the UE in a radio resource control (RRC)_IDLE state or an RRC_INACTIVE state, transmit a wake up signal (WUS) on one or more symbols except the identified at least one UL symbol.

14. The base station of claim 13, wherein in case that a first offset for a low power WUS occasion (LO) is configured based on a higher layer parameter, a reference frame for monitoring the WUS starts a number of frames prior to a paging frame associated with the LO, and
wherein the number of frames is indicated by the first offset.

15. The base station of claim 14, wherein a first monitoring occasion for the WUS is identified at the UE, based on a second offset relative to the reference frame.

16. The base station of claim 15, wherein the second offset is configured by a higher layer parameter.
